(19) United States
(12) Patent Application Publication
(10) Pub. No.: US 2023/0262687 A1
(43) Pub. Date: Aug. 17, 2023

(54) UPLINK TIMING MANAGEMENT IN COMMUNICATIONS SYSTEMS

(71) Applicant: QUALCOMM Incorporated, San Diego, CA (US)

(72) Inventors: Mohamad Sayed Hassan, Paris (FR); Lianghai Ji, San Diego, CA (US); Jun Ma, San Diego, CA (US); Liangping Ma, San Diego, CA (US)

(21) Appl. No.: 17/670,503

(22) Filed: Feb. 13, 2022

(51) Int. Cl. H04W 72/12; H04W 36/06

(52) U.S. Cl. CPC H04W 72/1268; H04W 36/06; H04W 72/1289

(57) ABSTRACT

Methods, systems, and devices for wireless communication at a user equipment (UE) are described. A UE may receive, at a source cell served by a network entity, signaling that triggers a handover to a target cell. The UE may also receive a first set of parameters associated with the target cell, the first set of parameters indicating that the target cell is served by the network entity. The UE may then transmit, to the target cell, an uplink communication in accordance with a timing advance value for the target cell. In some examples, the timing advance value for the target cell may be derived using a timing advance value for the source cell based on the target cell being served by the network entity.

### INTRODUCTION

The following relates to wireless communication at a user equipment (UE), including managing timing in wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE).

### SUMMARY

A method for wireless communication at a user equipment (UE) is described. The method may include receiving, at a source cell served by a network entity, signaling that triggers a handover to a target cell. In some examples, the network entity may include a communications device. The method may include receiving a first set of parameters associated with the target cell, the first set of parameters indicating that the target cell is served by the network entity. The method may further include transmitting, to the target cell, an uplink communication in accordance with a timing advance value for the target cell. In some examples, the timing advance value for the target cell may be derived using a timing advance value for the source cell based on the target cell being served by the network entity.

An apparatus for wireless communication at a UE is described. The apparatus may include a processor, memory coupled with the processor, the processor configured to receive, at a source cell served by a network entity, signaling that triggers a handover to a target cell. In some examples, the network entity may include a communications device. The processor may be configured to receive a first set of parameters associated with the target cell, the first set of parameters indicating that the target cell is served by the network entity. The processor may further be configured to transmit, to the target cell, an uplink communication in accordance with a timing advance value for the target cell. In some examples, the timing advance value for the target cell may be derived using a timing advance value for the source cell based on the target cell being served by the network entity.

Another apparatus for wireless communication at a UE is described. The apparatus may include means for receiving, at a source cell served by a network entity, signaling that triggers a handover to a target cell. In some examples, the network entity may include a communications device. The apparatus may include means for receiving a first set of parameters associated with the target cell, the first set of parameters indicating that the target cell is served by the network entity. The apparatus may further include means for transmitting, to the target cell, an uplink communication in accordance with a timing advance value for the target cell. In some examples, the timing advance value for the target cell may be derived using a timing advance value for the source cell based on the target cell being served by the network entity.

A non-transitory computer-readable medium storing code for wireless communication at a UE is described. The code may include instructions executable by a processor to receive, at a source cell served by a network entity, signaling that triggers a handover to a target cell. In some examples, the network entity may include a communications device. The code may include instructions executable by a processor to receive a first set of parameters associated with the target cell, the first set of parameters indicating that the target cell is served by the network entity. The code may further include instructions executable by a processor to transmit, to the target cell, an uplink communication in accordance with a timing advance value for the target cell. In some examples, the timing advance value for the target cell may be derived using a timing advance value for the source cell based on the target cell being served by the network entity.

Some examples of the method, apparatuses, and non-transitory computer-readable medium described herein may further include operations, features, means, or instructions for receiving a second set of parameters associated with the source cell and comparing the first set of parameters associated with the target cell to the second set of parameters associated with the source cell. Some examples of the method, apparatuses, and non-transitory computer-readable medium described herein may further include operations, features, means, or instructions for determining the network entity serving the target cell based on the comparing. In some examples, the network entity may be or represent a communications device.

Some examples of the method, apparatuses, and non-transitory computer-readable medium described herein may further include operations, features, means, or instructions for receiving, via a system information block, the first set of parameters including an identifier of the network entity and determining the network entity to serve the target cell based on the identifier.

Some examples of the method, apparatuses, and non-transitory computer-readable medium described herein may further include operations, features, means, or instructions for determining a timing value added to an estimated timing advance at the UE based on the target cell being served by the network entity, the timing advance value for the target cell derived using the timing value.

Some examples of the method, apparatuses, and non-transitory computer-readable medium described herein may further include operations, features, means, or instructions for determining a timing value for random access channel transmission based on the target cell being served by the network entity, the timing advance value for the target cell derived using the timing value.

Some examples of the method, apparatuses, and non-transitory computer-readable medium described herein may further include operations, features, means, or instructions for receiving, from the target cell, a system information block including the first set of parameters associated with the target cell. Some examples of the method, apparatuses, and non-transitory computer-readable medium described herein may further include operations, features, means, or instructions for receiving, from the source cell, the first set of parameters associated with the target cell.

Some examples of the method, apparatuses, and non-transitory computer-readable medium described herein may further include operations, features, means, or instructions for performing the handover to the target cell based on transmitting the uplink communication. In some examples of the method, apparatuses, and non-transitory computer-readable medium described herein, the first set of parameters includes at least one of ephemeris information, a common timing advance, a media access layer parameter, a cell-specific offset, or any combination thereof.

In some examples of the method, apparatuses, and non-transitory computer-readable medium described herein, media access layer parameter includes a scheduling offset parameter other than a cell-specific offset parameter. In some examples of the method, apparatuses, and non-transitory computer-readable medium described herein, the signaling that triggers the handover includes a handover command or a fulfilled conditional handover or both.

A method for wireless communication at a UE is described. The method may include receiving, at a source cell served by a network entity, signaling that triggers a handover to a target cell. In some examples, the network entity may include a communications device. The method may include receiving a timing advance command indicating a timing offset associated with the target cell. The method may further include transmitting, to the target cell, an uplink communication in accordance with a timing advance value for the target cell. In some examples, the timing advance value for the target cell may be derived based on the timing offset.

An apparatus for wireless communication at a UE is described. The apparatus may include a processor, memory coupled with the processor, the processor configured to receive, at a source cell served by a network entity, signaling that triggers a handover to a target cell. In some examples, the network entity may include a communications device. The processor may be configured to receive a timing advance command indicating a timing offset associated with the target cell. The processor may further be configured to transmit, to the target cell, an uplink communication in accordance with a timing advance value for the target cell. In some examples, the timing advance value for the target cell may be derived based on the timing offset.

Another apparatus for wireless communication at a UE is described. The apparatus may include means for receiving, at a source cell served by a network entity, signaling that triggers a handover to a target cell. In some examples, the network entity may include a communications device. The apparatus may include means for receiving a timing advance command indicating a timing offset associated with the target cell. The apparatus may further include means for transmitting, to the target cell, an uplink communication in accordance with a timing advance value for the target cell. In some examples, the timing advance value for the target cell derived based on the timing offset.

A non-transitory computer-readable medium storing code for wireless communication at a UE is described. The code may include instructions executable by a processor to receive, at a source cell served by a network entity, signaling that triggers a handover to a target cell. In some examples, the network entity may include a communications device. The code may include instructions executable by a processor to receive a timing advance command indicating a timing offset associated with the target cell. The code may further include instructions executable by a processor to transmit, to the target cell, an uplink communication in accordance with a timing advance value for the target cell. In some examples, the timing advance value for the target cell derived based on the timing offset.

Some examples of the method, apparatuses, and non-transitory computer-readable medium described herein may further include operations, features, means, or instructions for receiving an information element indicating that the target cell may be served by the network entity, the timing advance value derived based on the information element.

Some examples of the method, apparatuses, and non-transitory computer-readable medium described herein may further include operations, features, means, or instructions for receiving an information element indicating that the UE is to use the timing offset associated with the target cell to derive the timing advance value for the target cell.

Some examples of the method, apparatuses, and non-transitory computer-readable medium described herein may further include operations, features, means, or instructions for determining that the timing advance command includes a valid timing advance command value and determining that the target cell may be served by the network entity based on the timing advance command including the valid timing advance command value. Some examples of the method, apparatuses, and non-transitory computer-readable medium described herein may further include operations, features, means, or instructions for performing the handover to the target cell based on transmitting the uplink communication.

In some examples of the method, apparatuses, and non-transitory computer-readable medium described herein, the signaling that triggers the handover includes the timing advance command or an information element or both. In some examples of the method, apparatuses, and non-transitory computer-readable medium described herein, the signaling that triggers the handover includes a handover command or a fulfilled conditional handover or both.

A method for wireless communication at a network entity is described. The method may include outputting signaling that triggers a handover from a source cell to a target cell. The method may include outputting a first set of parameters associated with the target cell. The method may further include obtaining an uplink communication in accordance with a timing advance value for the target cell. In some examples, the timing advance value for the target cell may be derived using a timing advance value for the source cell.

An apparatus for wireless communication at a network entity is described. The apparatus may include a processor, memory coupled with the processor, the processor configured to output signaling that triggers a handover from a source cell to a target cell. The processor may be configured to output a first set of parameters associated with the target cell. The processor may further be configured to obtain an uplink communication in accordance with a timing advance value for the target cell. In some examples, the timing advance value for the target cell may be derived using a timing advance value for the source cell.

Another apparatus for wireless communication at a network entity is described. The apparatus may include means for outputting signaling that triggers a handover from a source cell to a target cell. The apparatus may include means for outputting a first set of parameters associated with the target cell. The apparatus may further include means for obtaining an uplink communication in accordance with a timing advance value for the target cell. In some examples, the timing advance value for the target cell may be derived using a timing advance value for the source cell.

A non-transitory computer-readable medium storing code for wireless communication at a network entity is described. The code may include instructions executable by a processor to output signaling that triggers a handover from a source cell to a target cell. The code may include instructions executable by a processor to output a first set of parameters associated with the target cell. The code may further include instructions executable by a processor to obtain an uplink communication in accordance with a timing advance value for the target cell. In some examples, the timing advance value for the target cell may be derived using a timing advance value for the source cell.

In some examples of the method, apparatuses, and non-transitory computer-readable medium described herein, the first set of parameters indicates that the source cell and the target cell may be served by the network entity. In some examples, the network entity may be or include a communications device.

Some examples of the method, apparatuses, and non-transitory computer-readable medium described herein may further include operations, features, means, or instructions for outputting an identifier of the network entity and determining the network entity serving the target cell based on the identifier.

Some examples of the method, apparatuses, and non-transitory computer-readable medium described herein may further include operations, features, means, or instructions for determining a timing value for an estimated timing advance based on the source cell and the target cell being served by the network entity, the timing advance value for the target cell being based on the timing value.

Some examples of the method, apparatuses, and non-transitory computer-readable medium described herein may further include operations, features, means, or instructions for determining a timing value for random access channel transmission based on the source cell and the target cell being served by the network entity, the timing advance value for the target cell being based on the timing value. Some examples of the method, apparatuses, and non-transitory computer-readable medium described herein may further include operations, features, means, or instructions for outputting a system information block including the first set of parameters associated with the target cell.

In some examples of the method, apparatuses, and non-transitory computer-readable medium described herein, the first set of parameters includes at least one of ephemeris information, a common timing advance, a media access layer parameter, a cell-specific offset, or any combination thereof. In some examples of the method, apparatuses, and non-transitory computer-readable medium described herein, media access layer parameter includes a scheduling offset parameter other than a cell-specific offset parameter. In some examples of the method, apparatuses, and non-transitory computer-readable medium described herein, the signaling that triggers the handover includes a handover command or a fulfilled conditional handover or both.

A method for wireless communication at a network entity is described. The method may include outputting signaling that triggers a handover from a source cell to a target cell. The method may include outputting a timing advance command indicating a timing offset associated with the target cell. The method may further include obtaining an uplink communication in accordance with a timing advance value for the target cell. In some examples, the timing advance value for the target cell may be based on the timing offset.

An apparatus for wireless communication at a network entity is described. The apparatus may include a processor, memory coupled with the processor, the processor configured to output signaling that triggers a handover from a source cell to a target cell. The processor may be configured to output a timing advance command indicating a timing offset associated with the target cell. The processor may further be configured to obtain an uplink communication in accordance with a timing advance value for the target cell. In some examples, the timing advance value for the target cell may be based on the timing offset.

Another apparatus for wireless communication at a network entity is described. The apparatus may include means for outputting signaling that triggers a handover from a source cell to a target cell. The apparatus may include means for outputting a timing advance command indicating a timing offset associated with the target cell. The apparatus may further include means for obtaining an uplink communication in accordance with a timing advance value for the target cell. In some examples, the timing advance value for the target cell may be based on the timing offset.

A non-transitory computer-readable medium storing code for wireless communication at a network entity is described. The code may include instructions executable by a processor to output signaling that triggers a handover from a source cell to a target cell. The code may include instructions executable by a processor to output a timing advance command indicating a timing offset associated with the target cell. The code may further include instructions executable by a processor to obtain an uplink communication in accordance with a timing advance value for the target cell. In some examples, the timing advance value for the target cell may be based on the timing offset.

Some examples of the method, apparatuses, and non-transitory computer-readable medium described herein may further include operations, features, means, or instructions for outputting an information element indicating that the target cell may be served by a network entity.

Some examples of the method, apparatuses, and non-transitory computer-readable medium described herein may further include operations, features, means, or instructions for outputting an information element indicating that the timing advance value may be based on the timing offset associated with the target cell.

### BRIEF DESCRIPTION OF THE DRAWINGS

FIG. 1 illustrates an example of a wireless communications system that supports uplink timing management in communications systems in accordance with one or more aspects of the present disclosure.

FIGS. 2A and 2B illustrate examples of wireless communications systems that support uplink timing management in communications systems in accordance with one or more aspects of the present disclosure.

FIG. 3 illustrates an example of a wireless communications system that supports uplink timing management in communications systems in accordance with one or more aspects of the present disclosure.

FIG. 4 illustrates an example of a process flow that supports uplink timing management in communications systems in accordance with one or more aspects of the present disclosure.

FIG. 5 illustrates an example of a process flow that supports uplink timing management in communications systems in accordance with one or more aspects of the present disclosure.

FIGS. 6 and 7 show block diagrams of devices that support uplink timing management in communications systems in accordance with one or more aspects of the present disclosure.

FIG. 8 shows a block diagram of a communications manager that supports uplink timing management in communications systems in accordance with one or more aspects of the present disclosure.

FIG. 9 shows a diagram of a system including a device that supports uplink timing management in communications systems in accordance with one or more aspects of the present disclosure.

FIGS. 10 and 11 show block diagrams of devices that support uplink timing management in communications systems in accordance with one or more aspects of the present disclosure.

FIG. 12 shows a block diagram of a communications manager that supports uplink timing management in communications systems in accordance with one or more aspects of the present disclosure.

FIG. 13 shows a diagram of a system including a device that supports uplink timing management in communications systems in accordance with one or more aspects of the present disclosure.

FIGS. 14 through 19 show flowcharts illustrating methods that support uplink timing management in communications systems in accordance with one or more aspects of the present disclosure.

### DETAILED DESCRIPTION

A wireless communications system may support non-terrestrial networks. In non-terrestrial networks (e.g., wireless communications systems supporting non-terrestrial communications devices), a UE may establish an initial connection with a non-terrestrial communications device (e.g., a satellite). In some examples, a non-terrestrial communications device may be configured to provide communications coverage in a cell or in multiple cells (e.g., multiple cells served by a common satellite). A cell may be defined as a logical communication entity used for communication between a UE and the non-terrestrial communications device (e.g., over a carrier). Additionally or alternatively, a cell may also refer to a geographic coverage area or a portion of a geographic coverage area (e.g., a sector) over which the logical communication entity operates. Such cells may be geographical areas providing communication coverage using the frequency emitted by a non-terrestrial communications device in a non-terrestrial network. When communicating in a cell (e.g., within the geographic coverage area of a cell), a UE may calculate a timing advance value. The timing advance value may include a timing offset for adjusting a timing of an uplink transmission (to account for a distance between a UE and a communications device). The UE may use the timing advance value to offset transmission of an uplink communication or reception of a downlink communication or both. For example, the UE may delay an uplink transmission by a timing advance value to align the reception of the uplink transmission at the communications device.

In some instances, a UE may handover from communicating on a first cell (e.g., source cell) to communicating on a second cell (e.g., target cell). The UE may be a mobile UE and may move out of a coverage area of the source cell. For example, the UE may receive a signal to initiate a handover process for the UE. Additionally or alternatively, the UE may request for a handover process and a base station may confirm the handover request (e.g., based on a resource availability at the target cell). In some examples, a non-terrestrial communications device (e.g., a satellite) providing a coverage area for a cell may move and the cells may change positions resulting in a handover of the UE. Upon handover, when a UE switches to a target cell, the UE may recalculate one or more timing advance values for the target cell. For instance, the UE may erase timing advance values associated with the source cell when transmitting a message on the target cell. Various described techniques provide for intra-satellite handovers. For example, the target cell may be associated with the same non-terrestrial device (e.g., satellite) as the source cell. In some examples, upon switching to the target cell, the UE may transmit a random access message (e.g., an uplink random access preamble). In some examples, a random access procedure may include transmission of a random access preamble and reception of a random access response. The UE may initiate calculation of the timing advance values upon handover to the target cell. In particular, the UE may recalculate the timing advance values even when the target cell and the source cell are served by the same communications device. Recalculating timing advance values may incur additional processing at the UE as a timing advance for the target cell may be same or similar to the timing advance for the source cell (since the target cell and the source cell are associated with the same satellite). Additionally or alternatively, the UE may flush (e.g., discard, delete or otherwise not consider) timing advance values associated with the source cell when transmitting a random access message (e.g., msg1 or msgA) to the target cell, because there may not be information at the UE indicating that the source cell and target cell are communicating with UE via same satellite.

One or more techniques depicted herein provide for repurposing timing advance values associated with a source cell when calculating a timing advance value for a target cell. For example, a UE and a satellite may communicate at a source cell. The UE and the satellite may then transition communications such that the UE may perform a handover and may subsequently communicate at a target cell that may be different than the source cell. In such cases, when triggered to initiate a handover (e.g., upon receiving a signal to initiate handover), the UE may receive a set of parameters (e.g., identifiers, ephemeris information, etc.) associated with the satellite serving the target cell. The UE may detect that the target cell is served by the same satellite as the source cell, and may derive a timing advance value for the target cell using a timing advance value for the source cell. In some examples, the timing advance value for the target cell may be the same as the timing advance value for the source cell. In some examples, the UE may transmit an uplink transmission using the derived timing advance value for the target cell. Additionally or alternatively, when triggered to initiate a handover (e.g., upon receiving a signal to initiate handover), the UE may receive a timing advance command from a network entity. In some examples, the network entity may include an indication of a timing offset. Additionally or alternatively, the UE may receive an indicator indicating whether the target cell is served by the same satellite as the source cell. In some examples, the received indicator may further indicate whether the UE is to use the timing advance value for the source cell to derive a timing advance value for the target cell. For example, the received indicator may include an information element indicating whether the target cell is served by the same satellite as the source cell. Additionally, the information element may indicate the timing advance value to be used by the UE when communicating on the target cell. If the received indicator includes the information element indicating the common satellite and the timing advance value, then the UE may calculate a timing advance value for transmitting an uplink transmission in accordance with the timing offset and the received indicator. In some examples, the UE may transmit the uplink transmission using the calculated timing advance value for the target cell.

Communications devices having the capability to perform uplink timing management may utilize the techniques described herein to experience power savings, such as extended battery life, by repurposing timing information associated with a source cell when communicating on a target cell. In particular, deriving timing advance values for a target cell using timing advance values for a source cell (instead of flushing timing advance values associated with the source cell when transmitting a message on the target cell) provides reliable and efficient communications between UEs, non-terrestrial communications devices and base stations, as the target cell and the source cell are served by the same non-terrestrial communications device. The techniques employed by the described UEs may provide time savings as the UE may reliably use the calculated timing advance values to communicate on a target cell (instead of flushing the timing advance values). The described techniques may thus include features for power consumption process, in some examples, may promote efficiency.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to uplink timing management in communications systems.

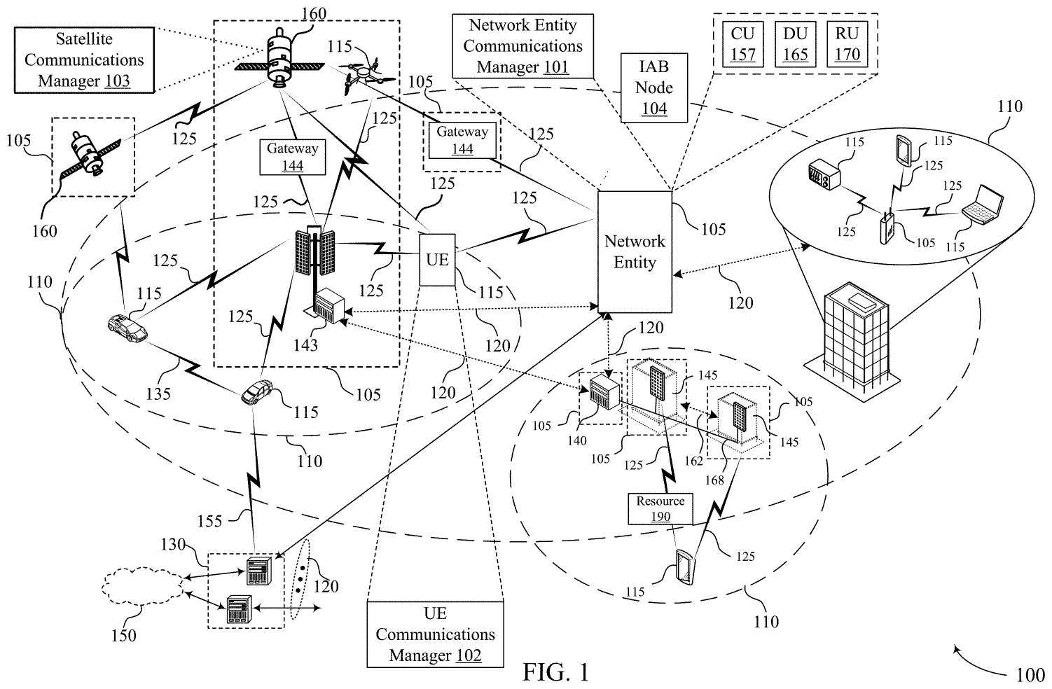

FIG. 1 illustrates an example of a wireless communications system 100 that supports uplink timing management in communications systems in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like. As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. In some examples, the backhaul links 120 may be or include one or more wireless links. The UE 115 may communicate with the core network 130 through communication link 155.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

One or more of the network entities 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology. Additionally or alternatively, the network entities 105 described herein may include or may be referred to by a person having ordinary skill in the art as a gateway 144, a non-terrestrial communications device (e.g., satellite) 160, or an entity including one or more of a base station 143, a gateway 144 or a non-terrestrial communications device (e.g., satellite) 160.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource 190 may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 (e.g., a base station 143, a gateway 144, a satellite 160, or an entity including the base station 143, the gateway 144, the satellite 160) may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may support synchronous or asynchronous operation. For synchronous operation, the network entities 105 may have similar frame timings, and transmissions from different network entities 105 may be approximately aligned in time. For asynchronous operation, the network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

One or more of the network entities 105 described herein may include or may be referred to as a base station 143 (e.g., a base transceiver station, a radio base station, an access point, a radio transceiver, a NodeB, an eNB, a next-generation NodeB or a giga-NodeB (either of which may be referred to as a gNB), a next-generation eNB (ng-eNB), a Home NodeB, a Home eNodeB, or other suitable terminology). A network entity 105 may also include or be referred to as other communications devices (e.g., a base station 143 or a gateway 144 or a satellite 160). A network entity 105 may also include or be referred to an entity including one or more of a base station 143, a gateway 144, a satellite 160 or a combination thereof. For example, a network entity 105 may include a subset of the base station 143, the gateway 144 and the satellite 160. The network entity 105 may be implemented in an aggregated or monolithic base station architecture, or alternatively, in a disaggregated base station architecture.

Thus, as described herein, a network entity 105 may include one or more components that are located at a single physical location or one or more components located at various physical locations. In examples in which the network entity 105 includes components that are located at various physical locations, the various components may each perform various functions such that, collectively, the various components achieve functionality that is similar to a base station that is located at a single physical location. As such, a network entity 105 described herein may equivalently refer to a standalone base station (also known as a monolithic base station) or a base station including components that are located at various physical locations or virtualized locations (also known as a disaggregated base station). In some implementations, such a network entity 105 including components that are located at various physical locations may be referred to as or may be associated with a disaggregated radio access network (RAN) architecture, such as an Open RAN (O-RAN) or Virtualized RAN (VRAN) architecture. In some implementations, such components of a network entity 105 may include or refer to one or more of a central unit (or centralized unit CU), a distributed unit (DU), or a radio unit (RU).

The wireless communications system 100 may operate using one or more frequency bands, for example, in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A medium access control layer may perform priority handling and multiplexing of logical channels into transport channels. The medium access control layer may also use error detection techniques, error correction techniques, or both to support retransmissions at the medium access control layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Techniques described herein, in addition to or as an alternative to be carried out between UEs 115 and network entities 105, may be implemented via additional or alternative wireless devices, including IAB nodes 104, DUs 165, CUs 157, RUs 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 157, the DU 165, and the RU 170. The split of functionality between the CU 157, DU 165, and RU 175 is flexible and as such gives rise to numerous permutations of different functionalities depending upon which functions (e.g., medium access control functions, baseband functions, radio frequency functions, and any combinations thereof) are performed at the CU 157, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 157, DUs 165, and RUs 170 and may be referred to as donor network entities 105 or IAB donors. One or more DUs 165 (e.g., and/or RUs 170) associated with a donor network entity 105 may be partially controlled by CUs 157 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein. In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 157 and at least one DU 165 (e.g., and RU 170), where the CU 157 may communicate with the core network 130 over an NG interface (e.g., some backhaul link). The CU 157 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, medium access control, physical (PHY), etc.) functionality and signaling, and may each be at least partially controlled by the CU 157. The DU 165 may support one or multiple different cells. IAB donor and IAB nodes 104 may communicate over an F1 interface according to some protocol that defines signaling messages (e.g., F1 AP protocol). Additionally, CU 157 may communicate with the core network over an NG interface (which may be an example of a portion of backhaul link), and may communicate with other CUs 157 (e.g., a CU 157 associated with an alternative IAB donor) over an Xn-C interface (which may be an example of a portion of a backhaul link).

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 157 and a DU 165, or between a DU 165 and an RU 170 may be within a protocol layer (e.g., some functions for a protocol layer may be performed by one of a CU 157, a DU 165, or an RU 170, while other functions of the protocol layer are performed by a different one of the CU 157, the DU 165, or the RU 170). A CU 157 may be functionally split further into CU control plane (CU-CP) and CU user plane (CU-UP) functions. A CU 157 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 157 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 157 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for using timing information to select or reselect a cell, as described herein. In some examples, the techniques described herein may be configured to support cell selection or reselection in non-terrestrial networks with large round-trip times in random access channel procedures. For example, some operations described as being performed by a UE 115 or a network entity 105 may additionally or alternatively be performed by components of the disaggregated RAN architecture (e.g., IAB nodes, DUs, CUs, etc.).

In the case of the techniques described herein applied in the context of a disaggregated RAN architecture, one or more components of the disaggregated RAN architecture may be configured to support uplink timing management in communications systems as described herein. For example, some operations described as being performed by a UE 115 or a network entity 105 (e.g., a base station 143 or a satellite or both) may additionally, or alternatively, be performed by one or more components of the disaggregated RAN architecture. It is to be understood that one or more components of the network entity 105 may be configured to support uplink timing management in communications systems as described herein.

A wireless multiple-access communications system may include a number of network entities or network access nodes, each simultaneously supporting communication for multiple communications devices, which may be otherwise known as UE. In some wireless communications system, a network entity and a UE may implement beamforming to initiate and continue communication.

Wireless communications system 100 may also include one or more satellites 160. Satellite 160 may communicate with base stations 143 and UEs 115 (or other high altitude or terrestrial communications devices). In some examples, a gateway 144 may serve as a relay between satellite 160 and base station 143. Satellite 160 may be any suitable type of communication satellite configured to relay communications between different end nodes in a wireless communication system. Satellite 160 may be an example of a space satellite, a balloon, a dirigible, an airplane, a drone, an unmanned aerial vehicle, a high-altitude platform system (HAPS), and/or the like. In some examples, the satellite 160 may be in a geosynchronous or geostationary earth orbit, a low earth orbit (LEO) or a medium earth orbit. A satellite 160 may be a multi-beam satellite configured to provide service for multiple service beam coverage areas in a predefined geographical service area. The satellite 160 may be any distance away from the surface of the earth.

In some cases, a cell may be provided or established by a satellite 160 as part of a non-terrestrial network. A satellite 160 may, in some cases, perform the functions of a base station 143, act as a bent-pipe satellite, or may act as a regenerative satellite, or a combination thereof. In some cases, a base station 143 may be within a satellite 160. In other cases, satellite 160 may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit those signals to different ground stations. In some cases, a bent-pipe transponder or satellite may amplify signals or shift from UL frequencies to DL frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof. For example, a bent-pipe satellite (e.g., satellite 160) may receive a signal from a base station 143 and may relay the signal to a UE 115 or base station 143, or vice-versa.

According to one or more aspects, in terrestrial networks, a UE 115 may determine a timing advance according to T_{TA}=(N_{TA}+N_{TA}, offset)*T_{c}. The UE 115 may receive a timing advance (N_{TA}) measured by a network entity. The timing advance N_{TA} may be measured by the network entity and sent to the UE 115. The timing advance N_{TA} may be dynamically controlled by the network. For initial access (random access channel transmission or msg1 transmission or msgA transmission), the UE 115 may assume the timing advance N_{TA} to be 0. The timing advance N_{TA} may be updated through an initial timing advance command in random access response (e.g., through msg2 transmission or msgB transmission). The UE 115 may receive the timing advance command in a control signal (e.g., medium access control layer control element) after a random access procedure. N_{TA,offset} may be dependent on frequency band, subcarrier spacing and coexistence of wireless networks. In some examples, T_{c} may be a constant.

In non-terrestrial networks, the UE 115 may determine the timing advance in accordance with T_{TA}=(N_{TA}+N_{TA,UE-specific}+N_{TA,common}+N_{TA,offset})×T_{c}. In such cases, N_{TA} may be defined as 0 for random access channel transmissions and updated based on timing advance command, N_{TA,UE-specific} may be estimated at the UE 115 to pre-compensate for service link delay, N_{TA,common} may be network-controlled common timing advance, and may include any timing offset indicated by the network entity. Additionally, the UE 115 may support N_{TA,common} with value of 0 and N_{TA,offset} as a fixed offset used to calculate the timing advance.

In some examples, the UE 115 may receive an update to N_{TA}. Upon receiving an update, the UE 115 may adjust the N_{TA} in accordance with

$${N}_{TA} = {N}_{TA\_old} + {T}_{A} * 16 * \frac{64}{{2}^{m}} .$$

Upon receiving an updated timing advance value, the UE 115 may adjust the N_{TA} in accordance with

$${N}_{TA\_new} = {N}_{TA\_old} + ( {T}_{A} + 31 ) * \frac{16 * 64}{{2}^{m}} ,$$

where T_{A} includes the timing advance indicated in a medium access control layer control element.

In non-terrestrial networks, a UE 115 may receive a signal to handover from a source cell to a target cell. In some wireless communications systems, the UE 115 may recalibrate the timing advance calculation upon handover to the target cell. However, in some cases, the source cell and the target cell may be served by a common communications device (e.g., satellite). In such cases of intra-satellite handover, the UE 115 may be configured to use the timing advance value calculated for the source cell to communicate with the target cell.

According to one or more aspects depicted herein, the UE 115 may use a UE communications manager 102 to receive, at a source cell served by a communications device 160 and from a network entity communications manager 101 at a base station 143, signaling that triggers a handover to a target cell. The UE communications manager 102 may then receive a first set of parameters associated with the target cell, the first set of parameters indicating that the target cell is served by the communications device 160. The base station 143 may communicate with the communications device 160 at satellite communications manager 103. In some examples, the network entity communications manager 101 may be the same as the satellite communications manager 103. Additionally or alternatively, the network entity communications manager 101 may include the satellite communications manager 103. In some examples, the UE communications manager 102 may transmit, to the target cell, an uplink communication in accordance with a timing advance value for the target cell. In some examples, the timing advance value for the target cell may be derived using a timing advance value for the source cell based on the target cell being served by the communications device 160.

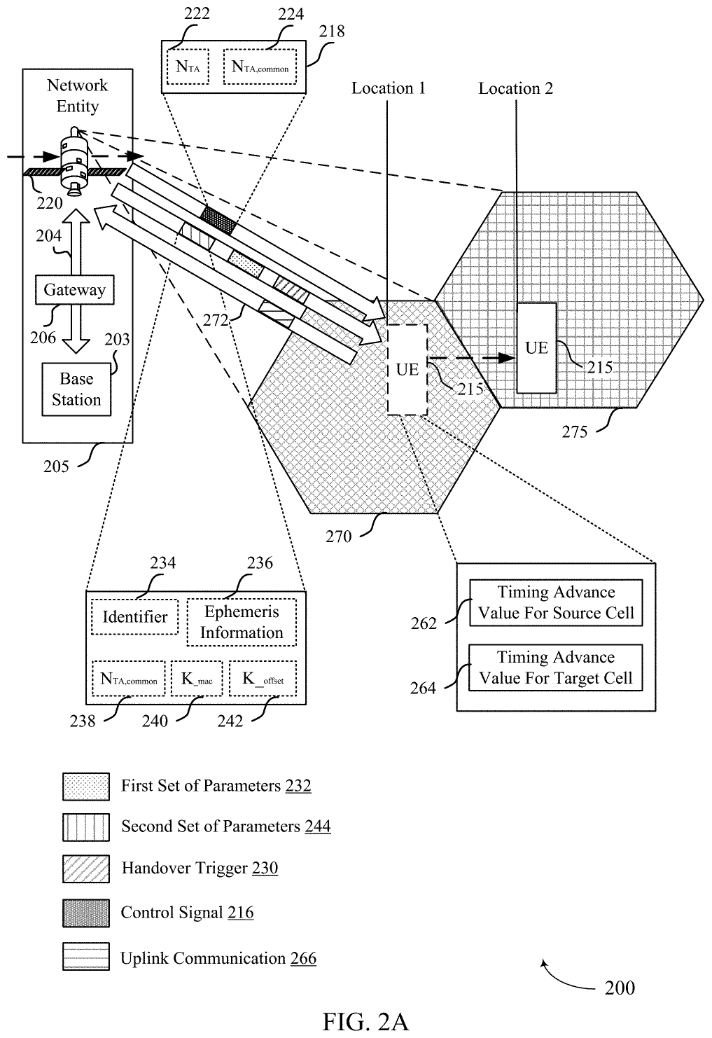

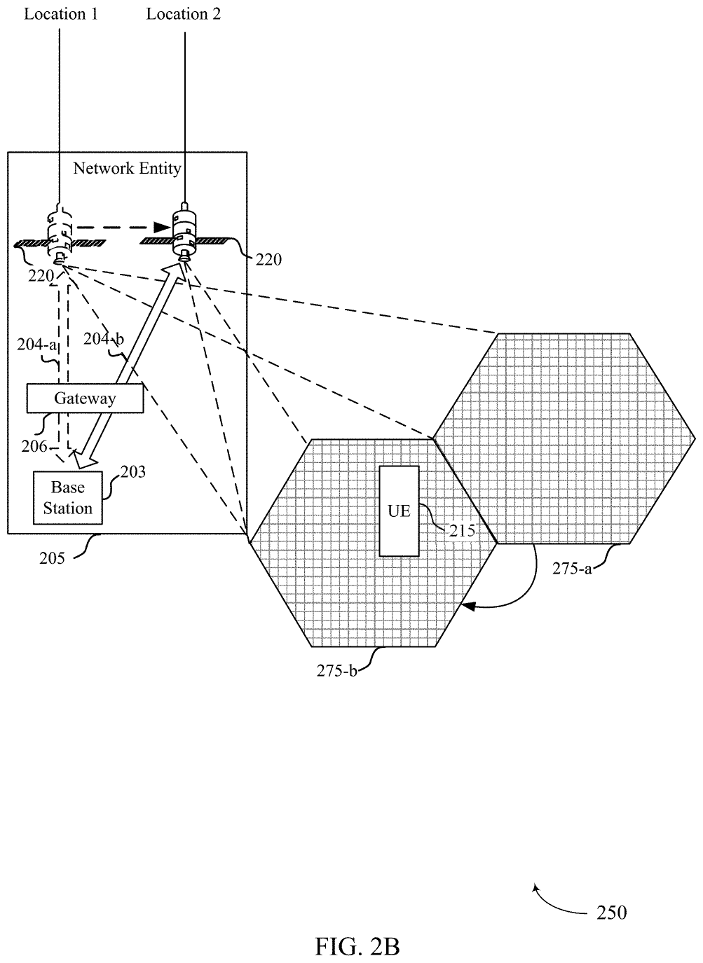

FIGS. 2A and 2B illustrate examples a wireless communications system 200 and a wireless communications system 250 that support uplink timing management in communications systems in accordance with one or more aspects of the present disclosure. In some examples, the wireless communications system 200 may implement aspects of wireless communications system 100. In some examples, the wireless communications system 250 may implement aspects of wireless communications system 100 and the wireless communications system 200. The wireless communications system 200 may include a network entity 205 (e.g., an entity including a base station, a gateway, and a satellite) and a UE 215. The network entity 205 may include a base station 203, a gateway 206, and a communications device 220 (e.g., satellite). The base station 203 and the communications device 220 described in FIG. 2A may be examples of the base stations 143 or a network entity described with reference to FIG. 1.

Additionally or alternatively, the communications device 220 may be an example of non-terrestrial devices, such as satellites 160. In some examples, the network entity 205 may be referred to as a network device and/or a next generation NodeB (gNB). Additionally or alternatively, the network entity 205 may include the communications device 220. In some examples, the network entity 205 may include the gateway 206. In some examples, the network entity 205 may include a source base station or a target base station or both. The UE 215 may be an example of a UE 115 described with reference to FIG. 1. The network entity 205 may be an example of a serving base station 143 for the UE 215. The communication between the base station 203 and a satellite (e.g., communications device 220) may be assisted by a gateway 206 which relays traffic over a communication link that may be referred to as a feeder link. Other base stations may be examples of neighboring base stations 143 and may be present in the wireless communications system 200. The wireless communications system 200 may support O-RAN architecture. In the example of FIGS. 2A and 2B, the network entity 205 may include components that are located at various physical locations.

FIG. 2A describes signaling between a UE and a network entity upon reception of a handover trigger. In FIG. 2A, the UE 215 may be a mobile UE in motion. In particular, the UE 215 may move from a first location (Location 1) in a source cell 270 to a second location (Location 2) in a target cell 275. The UE 215 may perform a handover procedure based on changing a geographical location from a first location (Location 1) in the source cell 270 to a second location (Location 2) in the target cell 275. In the example of FIG. 2A, although the communications device 220 may be in motion, such motion may not result in a change of cell for the UE 215. Instead, the motion of the UE 215 may result in a change of cell (e.g., handover).

The wireless communications system 200 may illustrate operations of and communications between the UEs 215 and one or more communications devices 220 that support uplink time management for communication networks to increase accuracy for communications using timing measurements for cell handover. The UE 215 may be in communication with the network entity 205 (including the communications device 220, the base station 203 and the gateway 206). The base station 203 may communicate with the communications device 220 using communications link 204-a. In some examples, communicating with a network entity 205 (e.g., base station 203) may include the UE 215 receiving downlink control information and scheduling uplink communications in accordance with the downlink control information. In some instances, a UE 215 may receive a timing indication from a base station 203 or another entity included in the network entity 205. The UE 215 may use the timing indication to determine a timing advance value. The UE 215 may then apply the timing advance value to determine a timing for communication.

In some examples, the UE 215 may calculate a timing advance in non-terrestrial networks. To seamlessly continue communications, a UE may handover from a source cell to a target cell. For example, a network entity serving a source cell may initiate a handover to a target cell. In some instances, the UE 215 may be a mobile UE and may move out of a coverage area of the source cell 270. A timing advance value may be or may include a timing offset applied at the UE 215, between a start of a received downlink transmission and an uplink transmission. The UE 215 may use the timing offset to synchronize downlink and uplink transmissions at the network entity 205. As depicted in the example of FIG. 2A, the UE 215 may move out of the coverage area of the source cell 270 and may thus initiate a handover procedure.

Referring to FIG. 2B, the wireless communications system 250 may include a network entity 205 (e.g., an entity including a base station, a gateway, and a satellite) and a UE 215. The network entity 205 may include a base station 203, a gateway 206, and a communications device 220 (e.g., satellite). The base station 203 and the communications device 220 described in FIG. 2B may be examples of the base stations 143 or a network entity described with reference to FIG. 1. As described with reference to FIG. 2A, a UE 215 may transition away from a cell (e.g., a source cell) triggering a handover procedure.

FIG. 2B describes that a communications device (e.g., satellite) may be in motion and therefore change locations. The communications device 220 may serve multiple cells at the same time. In particular, the UE 215 may be static and the communications device 220 may be in motion. As depicted in the example of FIG. 2B, the communications device 220 may be located at the first location and may move from the first location (Location 1) to a second location (Location 2). While at the first location (Location 1), the communications device 220 may provide coverage for the cell 275-a (e.g. with physical cell identifier PCID1), the cell 275-b (e.g. with physical cell identifier PCID2) and other cells. The UE 215 may be in the coverage of the cell 275-b (e.g. with physical cell identifier PCID2). The communications device 220 may move from the first location (Location 1) to a second location (Location 2). Due to the movement of the communications device 220, the cell served by the communications device 220 may also change. For example, upon moving to the second location (Location 2), the communications device 220 may provide coverage for the cell 275-b (e.g. with physical cell identifier PCID1) and other cells. That is, the coverage area provided by the communications device 220 may change as the communications device 220 moves. At the new location (e.g., second location), the base station 203 may communicate with the communications device 220 using communications link 204-b (via the gateway 206). In such cases, the UE 215 may perform a handover to connect to cell 275-b (e.g. with physical cell identifier PCID1). Thus, the handover described herein may be initiated by the UE or the network.

During a handover, when a UE switches to a target cell, the UE may recalculate timing advance values for the new cell (or target cell). In some examples, a random access procedure may include transmission of a random access preamble and reception of a random access response. When initially connecting to a target cell, the UE may transmit the random access preamble. Additionally or alternatively, the UE may transmit data in addition to the random access preamble. In such cases, the UE may calculate a random access timing for the target cell upon handover without considering a timing advance offset for random access procedure (calculate the random access timing as being equal to 0). For example, the UE may transmit an uplink random access preamble (as part of the random access procedure) without applying a timing offset. In some examples, the target cell may be associated with the same communications device (e.g., satellite) as the source cell. In such cases, a timing advance for the target cell may be same or similar to the timing advance for the source cell. Additionally or alternatively, the timing advance for the target cell may be derived (or otherwise determined) using a timing advance for the source cell.

Techniques depicted herein provide for uplink time management by utilizing the timing calculated for a source cell when communicating with a target cell. Referring back to FIG. 2A, the UE 215 may communicate on a source cell 270. As depicted herein, a communications device 220 may provide communication coverage via one or more cells, for example a macro cell, a small cell, a hot spot, or other types of cells, or any combination thereof. The term “cell” may refer to a logical communication entity used for communication with a communications device 220 (e.g., over a carrier). Additionally or alternatively, the cell may refer to as a geographic coverage area or a portion of a geographic coverage area (e.g., a sector) over which the logical communication entity operates. As described with reference to FIG. 2A, the source cell 270 may provide communications over geographic coverage area and the target cell 275 may provide communications over geographic coverage area. A communications device may serve both a source cell and a target cell. In the example of FIG. 2A, the communications device 220 (e.g., satellite 220) assisted by the network entity 205 (e.g., base station 203) may provide communication coverage in the source cell 270 and the target cell 275. In some examples, a network entity 205 (e.g., base station 203) may be associated with a cell (e.g., source cell 270 and target cell 275) and can provide service for a UE 215 within the coverage area of the source cell 270 and the coverage area of the target cell 275. The UE 215 may move within the coverage area, and the communications device 220 in association with the network entity 205 serving the source cell 270 may provide wireless communications to UE 215. Additionally or alternatively, the UE 215 may move within the coverage area, and the communications device 220 in association with the network entity 205 serving the target cell 275 may provide wireless communications to UE 215.

In some cases, a cell (e.g., source cell 270 or target cell 275) may be provided or established by a communications device 220 (e.g., satellite) as part of a non-terrestrial network. In some examples, the communications device 220 may perform the functions of a base station, act as a bent-pipe satellite, or may act as a regenerative satellite, or a combination thereof. A bent-pipe transponder or satellite may be configured to receive signals from ground stations and transmit those signals to different ground stations. While acting as a bent-pipe satellite, the communications device 220 may communicate with a base station 203 (e.g., included in the network entity 205) via a gateway 206. Additionally or alternatively, the communications device 220 may communicate via a gateway 206 with a base station 203 and forward transmissions to the UE 215. In some examples, the communications device 220 may be an example of a regenerative satellite. In some examples, the wireless communications system 200 may support mixed payload types where the communications device 220 may be configured to receive signals from a base station supporting another communications device (not shown). Although FIG. 2A illustrates an example of a bent-pipe satellite, it may be understood that the connections between the communications devices 220 and the corresponding network entities are optional.

As depicted herein, the wireless communications system 200 may support handling cell handover in non-terrestrial networks. The wireless communications system 200 may support uplink timing management to enhance communications efficiency in a wireless communications system. The wireless communications system 200 may enable repurposing timing information of a source cell 270 after handover to a target cell 275 for efficient communication between a transmitter and a receiver (e.g., network entity 205 and UE 215). In some examples, the wireless communications system 200 may support timing signaling on several channels (e.g., over several connections). In some examples, the UE 215 may calculate one or more timing advance values associated with the source cell 270. In some examples, the communications device 220 (e.g., satellite) may include a radio unit. The network entity 205 may include a processing unit for processing one or more signals received from the UE 215. Alternatively, the communications device 220 may include components for on-board processing of the one or more signals transmitted by the UE 215.

According to one or more aspects depicted herein, a UE (e.g., UE 215) may be located at a distance from a network entity 205 (e.g., communications device 220). To offset propagation delay when communicating with the network entity 205, the UE 215 may apply a timing advance (e.g., timing offset) to calculate timing for uplink transmission. The UE 215 may use one or more parameters (either indicated by the network entity 205 or calculated at the UE) to determine the timing advance. In non-terrestrial networks, the timing advance applied by a UE (e.g., UE 215) may be calculated in accordance with T_{TA}=(N_{TA}+N_{TA,UE-specific}+N_{TA,common}+N_{TA,offset})×T_{c}, where N_{TA} may be defined as 0 for physical random access channel and updated based on a timing advance command field in a timing advance command (e.g., msg2 or msgB and medium access control layer control element timing advance command). N_{TA,UE-specific} may be UE self-estimated timing advance to pre-compensate for a service link delay (e.g., delay between a communication link between the UE 215 and the communications device 220) and N_{TA,common} may be network-controlled common timing advance, and may include timing offset indicated by a network entity (e.g., network entity 205). A service link may be a communication link between the UE 215 and the communications device 220. The UE may support N_{TA,common} with a value of 0. In some examples, N_{TA,common} may be broadcasted by a non-terrestrial network, and its value may be determined or controlled by the non-terrestrial network. The UE may use the N_{TA,common} to compensate the round trip delay between a satellite and a reference point (e.g., gateway 206) determined by the non-terrestrial network. Additionally, N_{TA,offset} may be a fixed offset and the UE may use N_{TA,offset} to calculate the timing advance. In some examples, T_{c} may be a constant.

As depicted in the example of FIG. 2A, the UE 215 communicating on a source cell 270, may receive a control signal 216 (e.g., medium access control layer control element including timing advance command 218). The control signal 216 may include N_{TA} 222 (in a timing advance command 218). Additionally or alternatively, the UE 215 may receive N_{TA,common} 224 to compensate for a round trip delay when communicating with the communications device 220. The UE 215 may use the indicated values (N_{TA} 222 and N_{TA,common} 224) to calculate a timing advance value 262 for the source cell 270 in accordance with T_{TA}=(N_{TA}+N_{TA,UE-specific}+N_{TA,common}+N_{TA,offset})×T_{c}. The UE 215 may communicate with the network entity 205 on the source cell 270 via the communications device 220 using the timing advance value 262 calculated for the source cell 270.

According to aspects depicted herein, the UE 215 may receive, at a source cell 270 served by a communications device 220, signaling (e.g., handover trigger 230) that triggers a handover to a target cell 275. The handover may be a initiated by the network or by a UE. In some examples, the trigger (e.g., handover trigger 230) may be a handover command, or a fulfilled conditional handover. The UE 215 may then detect a first set of parameters 232 associated with the target cell 275. In some examples, the UE 215 may receive the receiving the first set of parameters 232 from the network entity 205. In some examples, the first set of parameters may indicate that the target cell 275 is served by the communications device 220. That is, the first set of parameters 232 may indicate that the source cell 270 and the target cell 275 are both served by the same satellite (e.g., communications device 220).

In some examples, the first set of parameters may include at least one of ephemeris information 236, a common timing advance 238, a medium access control layer parameter 240, a cell-specific offset 242, or any combination thereof. In some examples, the medium access control layer parameter may include a scheduling offset parameter other than a cell-specific offset parameter. Additionally or alternatively, the first set of parameters 232 may include an identifier 234 for the communications device (e.g., satellite). For instance, the UE 215 may detect or determine one or more of a physical cell identifier 234, ephemeris information 236, N_{TA,common} value 238, K_mac value 240, and cell-specific K_offset value 242 associated with the target cell 275. In some examples, the UE 215 may receive, from the target cell 275, a system information block including the first set of parameters 232 associated with the target cell 275. Additionally or alternatively, the UE 215 may receive, from the source cell 270, the first set of parameters 232 associated with the target cell 275. For instance, the network entity 205 serving the source cell 270 may indicate the first set of parameters 232 to the UE 215. The UE 215 may receive the first set of parameters 232 from the source cell 270 under the context of handover preparation procedure or handover execution procedure.

According to aspects depicted herein, the UE 215 may receive a second set of parameters 244 associated with the source cell 270. The UE 215 may compare the first set of parameters 232 with the second set of parameters 244 to determine whether the target cell 275 is served by the same communications device 220. That is, the UE 215 may determine, prior to execution of a handover, whether the target cell 275 is served by the same satellite (e.g., communications device 220) as the source cell 270. In some examples, the UE 215 may detect that the target cell 275 is served by the same satellite and the same gateway or base station as the source cell 270 by comparing one or more of the ephemeris information, TA_{common}, the K_{mac}, and the cell-specific K_offset of the source cell and the target cell. Additionally or alternatively, if the UE 215 receives an identifier for the communications device 220, the UE 215 may determine that the source cell 270 and the target cell are served by the same satellite based on comparing satellite identifier (e.g., satellite index) serving the target cell 275 and satellite identifier (e.g., satellite index) serving the source cell 270. In some examples, the network entity 205 may transmit the satellite identifier (e.g., satellite index) via system information block and/or during handover.

Upon determining that the source cell 270 and the target cell 275 are served by the communications device (e.g., communications device 220), the UE 215 may determine a timing advance value 264 for the target cell 275 using a timing advance value 262 for the source cell 270. While in the coverage area of the target cell 275, the UE 215 may communicate with the communications device 220 using the timing advance value 264 for the target cell 275 (e.g., offset uplink communications according to the timing advance value). In some examples, the UE 215 may derive T_{TA}^{target} value (timing advance value 264) for the target cell 275 by using the N_{TA}^{source} value (e.g., N_{TA} 222) used for communicating with the source cell 270. In some examples, the UE 215 may determine a timing value added to an estimated timing advance (e.g., timing advance value 264 for the target cell 275) at the UE 215. For instance, the UE 215 may consider the N_{TA}^{source} when calculating N_{TA,UE-specific}, where N_{TA,UE-specific} may be self-estimated at the UE 215. For example, the UE 215 may add the N_{TA}^{source} (derived from N_{TA} 222) to N_{TA,UE-specific} to pre-compensate for service link delay. Additionally or alternatively, the UE 215 may determine a timing value for random access channel transmission based on the target cell 275 being served by the communications device 220. In some examples, the UE 215 may derive the timing advance value 264 for the target cell 275 using the timing value. For instance, the UE 215 may use N_{TA,UE-specific} carrying N_{TA}_{_{old}} (derived from N_{TA} 222) associated with the source cell 270 for random access channel communication (if the prior information is available). When generating the timing advance value 264 for the target cell 275, the UE 215 may assume N_{TA}_{_{old}}=N_{TA}^{source}, for random access channel if prior information is available (e.g., if the UE 215 has received the control signal 216). If the prior information is not available, the UE 215 may assume N_{TA} to be 0 for random access channel transmission.

In some examples, the UE 215 may transmit, to the target cell 275 (e.g., a target base station included in the network entity 205), an uplink communication 266 in accordance with the timing advance value 264 for the target cell 275. In some examples, the UE 215 may execute the handover or the fulfilled conditional handover by sending a msg1 or msgA (via communication link 272) to the target cell 275 by using the derived timing advance value (e.g., timing advance value 264 for the target cell 275). Thus, by implementing the techniques depicted herein, the UE 215 may repurpose timing advance values calculated for a source cell when communicating with a target cell based on determining that the source cell and the target cell are served by a common communications device.

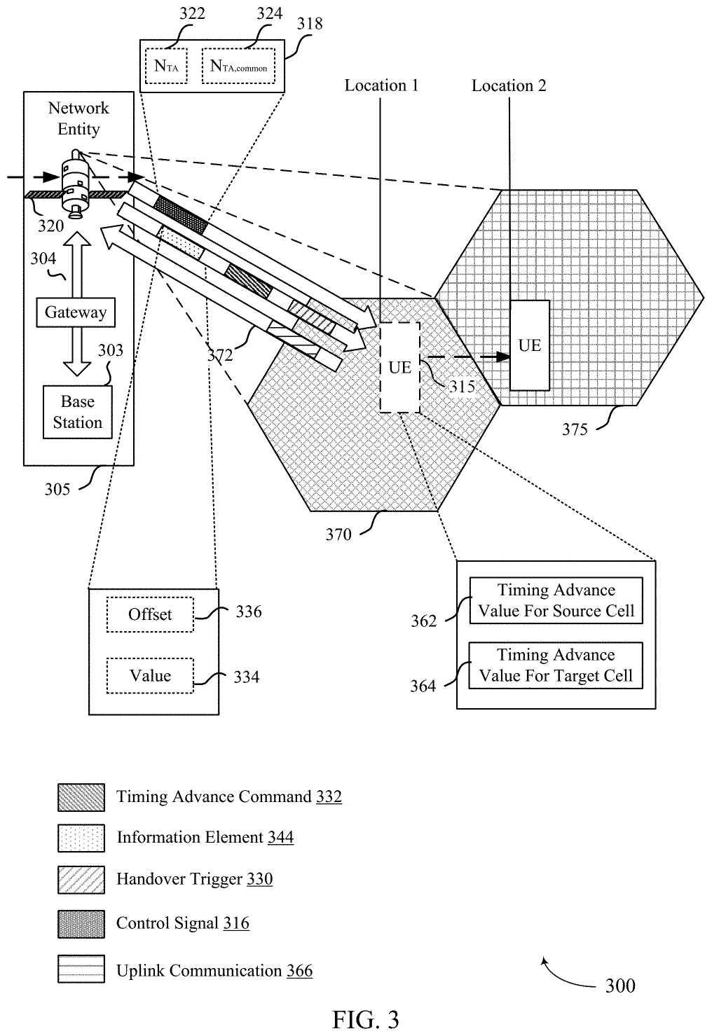

FIG. 3 illustrates an example of a wireless communications system 300 that supports uplink timing management in communications systems in accordance with one or more aspects of the present disclosure. In some examples, the wireless communications system 300 may implement aspects of wireless communications system 100 and the wireless communications system 200. The wireless communications system 300 may include a network entity 305 (e.g., an entity including a base station and a satellite), a base station 303, a UE 315, a gateway 306, and a communications device 320 (e.g., satellite). The base station 303 and the communications device 320 described in FIG. 3 may be examples of the base stations 143 or a network entity 105 described with reference to FIG. 1.

Additionally or alternatively, the communications device 320 may be an example of non-terrestrial devices, such as satellites 160. In some examples, the network entity 305 may be referred to as a network device and/or a next generation NodeB (gNB). The UE 315 may be an example of a UE 115 described with reference to FIG. 1. The base station 303 included in the network entity 305 may be an example of a serving base station 143 for the UE 315. The communication between the base station 303 and a satellite (e.g., communications device 320) may be assisted by a gateway 306 which relays traffic over a communication link that may be referred to as a feeder link. Although not depicted herein, other base stations may be examples of neighboring base stations 143 and may be present in the wireless communications system 300. The wireless communications system 300 may support O-RAN architecture. In the example of FIG. 3, the network entity 305 may include components that are located at various physical locations.

FIG. 3 describes signaling between a UE and a network entity upon reception of a handover trigger. In FIG. 3, the UE 315 may be a mobile UE in motion. In particular, the UE 315 may move from a first location (Location 1) in a source cell 370 to a second location (Location 2) in a target cell 375. The UE 315 may perform a handover procedure based on changing a geographical location from a first location (Location 1) in the source cell 370 to a second location (Location 2) in the target cell 375. In the example of FIG. 3, although the communications device 320 may be in motion, such motion may not result in a change of cell for the UE 315.

Although not depicted in the example of FIG. 3, it is to be understood that a communications device (e.g., satellite) may be in motion resulting in a change of cell. For instance, the UE 315 may be fixed and the communications device 320 may change locations. The movement of the communications device 320 may result in change of the cell served by the communications device 320 (as described with reference to FIG. 2B). Thus, the UE 315 may initiate a handover procedure based on a movement of the UE 315 (depicted in FIG. 3) or based on a movement of the communications device 320 (depicted in FIG. 2B) or both. Instead, the motion of the UE 315 may result in a change of cell (e.g., handover).

The wireless communications system 300 may illustrate operations of and communications between the network entity 305 and the UE 315 that support uplink time management for communication networks by using timing advance commands for a source cell when communicating with a target cell. Such techniques may increase accuracy and reduce latency for communications during cell handover. The UE 315 may be in communication with the communications device 320 included in the network entity 305. The communications device 320 and the base station 303 may communicate using communications link 304.

Techniques depicted herein provide for uplink time management by utilizing the timing calculated for a source cell when communicating with a target cell. As depicted in the example of FIG. 3, the UE 315 may communicate on a source cell 370. In the example of FIG. 3, the communications device 320 (e.g., satellite 320) assisted by the network entity 305 (e.g., including base station 303) may provide communication coverage within the source cell 370 and the target cell 375. In some examples, a network entity 305 (e.g., including base station 303) may be associated with a cell (e.g., source cell 370 and target cell 375) and can provide service for a UE 315 within the coverage area of the source cell 370 and the coverage area of the target cell 375. As depicted herein, a cell may refer to a logical communication entity used for communication with a communications device 320 (e.g., over a carrier). Additionally or alternatively, the cell may refer to as a geographic coverage area or a portion of a geographic coverage area (e.g., a sector) over which the logical communication entity operates. In the example of FIG. 3, the UE 315 may move within the coverage area of the source cell 370, and the communications device 320 in association with the network entity 305 serving the source cell 370 may provide wireless communications to UE 315. Additionally or alternatively, the UE 315 may move within the coverage area of the target cell 375, and the communications device 320 in association with the network entity 305 serving the target cell 375 may provide wireless communications to UE 315.

As depicted in the example of FIG. 3, the communications device 320 may perform the functions of a base station, act as a bent-pipe satellite, or may act as a regenerative satellite, or a combination thereof. In some examples, the wireless communications system 300 may support mixed payload types where the communications device 320 may be configured to receive signals from a base station supporting another communications device (not shown). Although FIG. 3 illustrates an example of a bent-pipe satellite, it may be understood that the connections between the communications devices 320 and the corresponding entities are optional.

According to one or more aspects of the present disclosure, the wireless communications system 300 may support handover from a source cell 370 to a target cell 375 in non-terrestrial networks. In some examples, the UE 315 may determine that the source cell 370 and the target cell 375 are served by a common communications device (e.g., communications device 320). For example, the communications device 320 may provide communication coverage in the coverage area for the source cell 370 and the coverage area for the target cell 375. The UE 315 may utilize techniques depicted in FIG. 2A to determine that the source cell 370 and the target cell 375 are served by a common communications device. The UE 315 may then repurpose timing information of the source cell 370 after handover to the target cell 375 for efficient communication between a transmitter and a receiver (e.g., network entity 305 and UE 315).

As depicted with reference to FIG. 2A, a UE (e.g., UE 315) may calculate a timing advance value to communicate with a network entity 305 (e.g., communications device 320). For instance, to offset a propagation delay when communicating with the network entity 305, the UE 315 may apply a timing advance (e.g., timing offset) to calculate timing for uplink transmission. In some examples, the timing advance applied by a UE (e.g., UE 315) may be calculated in accordance with T_{TA}=(N_{TA}+N_{TA,UE-specific}+N_{TA,common}+N_{TA,offset})×T_{c}, where N_{TA} may be defined as 0 for physical random access channel and updated based on a timing advance command field in a timing advance command (e.g., msg2 or msgB and medium access control layer control element timing advance command). N_{TA,UE-specific} may be UE self-estimated timing advance to pre-compensate for a service link delay and N_{TA,common} may be network-controlled common timing advance, and may include timing offset indicated by a network entity (e.g., network entity 305). The UE may support N_{TA,common} with a value of 0. In some examples, N_{TA,common} may be broadcasted by a non-terrestrial network, and its value may be determined or controlled by the non-terrestrial network. The UE may use the N_{TA,common} to compensate the round trip delay between a satellite and a reference point (e.g., gateway 306) determined by the non-terrestrial network. Additionally, N_{TA,offset} may be a fixed offset and the UE may use N_{TA,offset} to calculate the timing advance. In some examples, T_{c} may be a constant.

As depicted in the example of FIG. 3, the UE 315 communicating on a source cell 370, may receive a control signal 316 (e.g., medium access control layer control element including timing advance command 318). The control signal 316 may include N_{TA} 322 (in a timing advance command 318). Additionally or alternatively, the UE 315 may receive N_{TA,common} 324 to compensate for a round trip delay when communicating with the communications device 320. The UE 315 may use the indicated values (N_{TA} 322 and N_{TA,common} 324) to calculate a timing advance value 362 for the source cell 370 in accordance with T_{TA}=(N_{TA}+N_{TA,UE-specific}+N_{TA,common}+N_{TA,offset})×T_{c}. The UE 315 may communicate with the network entity 305 on the source cell 370 using the timing advance value 362 calculated for the source cell 370.

In some examples, the UE 315 may receive, at a source cell 370 served by the communications device 320, signaling (e.g., handover trigger 330) that triggers a handover to a target cell 375. In some examples, the trigger (e.g., handover trigger 330) may be a handover command, or a fulfilled conditional handover. The UE 315 may then receive a timing advance command 332 indicating a timing offset 336 associated with the target cell 375. In some examples, the UE 315 may receive an information element 344 or the timing advance command 332 or both. The UE 315 may use the information element 344 or the timing advance command 332 or both to derive a timing advance value 364 for the target cell 375. In some examples, the UE 315 may derive a T_{TA}^{target} value (timing advance value 364) for communicating with the target cell 375. For example, the UE 315 may communicate with the communications device 320 using the timing advance value 364 (e.g., offset uplink communications according to the timing advance value) while within the coverage area of the target cell 375. In some examples, the information element 344 or the timing advance command 332 or both may be included in the handover trigger 330. Additionally or alternatively, the network entity 305 may transmit the information element 344 or the timing advance command 332 or both separate from the handover trigger 330.

In some examples, the timing advance command 332 may include an additional offset 336 with respect to a N_{TA}^{source} value of the source cell 370. For instance, the UE 315 may derive T_{TA}^{target} value (timing advance value 364) for the target cell 375 by using an additional offset 336 with respect to the N_{TA}^{source} value (e.g., N_{TA} 322) used for communicating with the source cell 370. In some examples, the UE 315 may receive the information element 344 indicating that the target cell 375 is served by the same communications device 320 as the source cell 370. The UE 315 may derive the timing advance value 364 based on the information element 344. The information element 344 may indicate whether the target cell 375 is served by the same satellite and the same gateway or base station as the source cell 370. Additionally or alternatively, the information element 344 may indicate whether the UE 315 is to use N_{TA}^{source} value (e.g., N_{TA} 322) associated with the source cell 370 to derive the timing advance value 364 for communicating with the target cell 375. If the information element 344 indicates that the target cell 375 and the source cell 370 are served by the same satellite, and that the UE 315 is to use N_{TA}^{source} value to derive the timing advance value 364, then the UE 315 may derive the timing advance value 364 for target cell (e.g., T_{TA}^{target}) using N_{TA}^{source} value (e.g., N_{TA} 322).

In some examples, the UE 315 may receive the timing advance command 332 without the information element 344. In such cases, the timing advance command 332 may indicate a valid value 334 for timing calculation. The UE 315 may determine that the timing advance command 332 includes a valid timing advance command value 334. Additionally or alternatively, the UE 315 may determine that the target cell 375 is served by the communications device 320 based on the timing advance command 332 including the valid timing advance command value 334. For instance, a specific timing advance command value 334 may refer to an invalid timing advance command. In such cases, the UE 315 may interpret that target cell 375 and source cell 370 are served by different satellites (or different communications device). If the UE 315 determines that the timing advance command 332 may indicate a valid value 334, then the UE 315 may use N_{TA}^{source} value (e.g., N_{TA} 322) associated with the source cell 370 and the timing advance command 332 (e.g. additional offset 336) to derive the timing advance value 364 for communicating with the target cell 375. In some examples, the UE 315 may transmit, to the target cell 375, an uplink communication 366 in accordance with the timing advance value 364 for the target cell 375. In some examples, the UE 315 may derive the timing advance value 364 for the target cell 375 derived based on the timing offset 336. In some examples, the UE 315 may execute the handover or the fulfilled conditional handover by sending a msg1 or msgA (via communication link 372) to the target cell 375 by using the derived timing advance value (e.g., timing advance value 364 for the target cell 375).

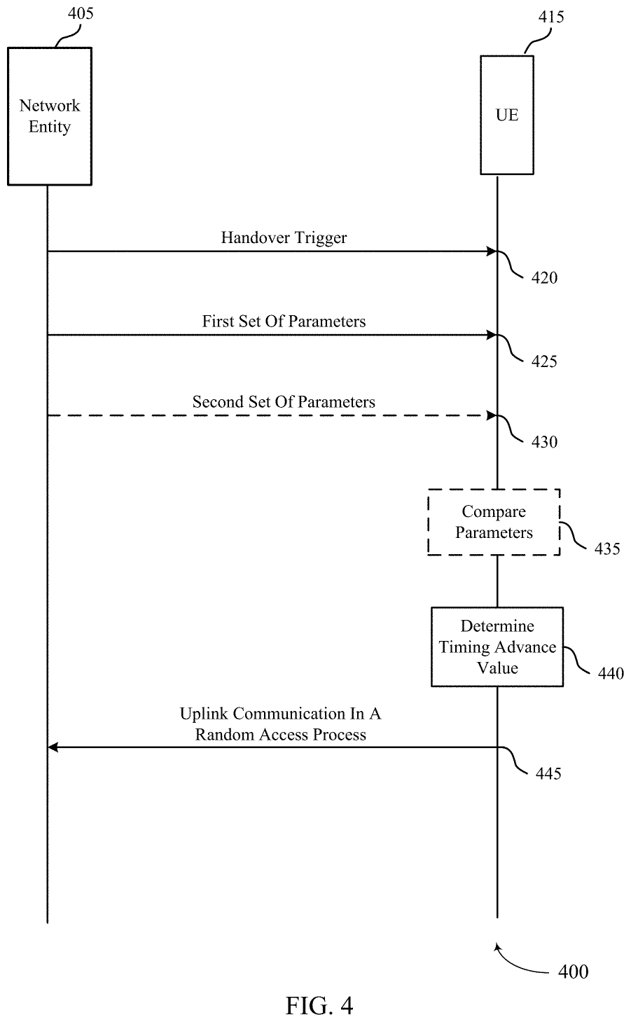

FIG. 4 illustrates an example of a process flow 400 that supports uplink timing management in communications systems in accordance with one or more aspects of the present disclosure. In some examples, the process flow 400 may implement aspects of wireless communications system 100, the wireless communications system 200 and the wireless communications system 300 described with reference to FIGS. 1, 2 and 3, respectively. For example, the process flow 400 may be based on one or more rules for timing advance determination in wireless communications systems. The process flow 400 may be implemented by the UE 415 and a network entity 405 for reduced power consumption, and may promote low latency and low interference for wireless communications, among others. The network entity 405 may include a base station and a communications device (e.g., satellite). The network entity 405 may be an example of a network entity 205 and a network entity 305, as described with reference to FIGS. 2 and 3. The UE 415 may be an example of a UE 115, as described with reference to FIGS. 1, 2 and 3.

In the following description of the process flow 400, the operations between the network entity 405 and the UE 415 may be transmitted in a different order than the example order shown, or the operations performed by the network entity 405 and the UE 415 may be performed in different orders or at different times. Some operations may also be omitted from the process flow 400, and other operations may be added to the process flow 400.

At 420, the UE 415 may receive, at a source cell served by a communications device, signaling that triggers a handover to a target cell. In some examples, the signaling that triggers the handover may include a handover command or a fulfilled conditional handover or both.

At 425, the UE 415 may receive a first set of parameters associated with the target cell. In some examples, the first set of parameters may indicate that the target cell is served by the communications device. That is, the UE 415 may determine that the target cell and the source cell are served by a common communications device (e.g., satellite). In some examples, the UE 415 may receive, via a system information block, the first set of parameters including an identifier of the communications device. The UE 415 may determine the communications device to serve the target cell based on the identifier.

In some examples, the first set of parameters may include at least one of ephemeris information associated with the target cell, a common timing advance associated with the target cell, a medium access control layer parameter associated with the target cell, a cell-specific offset associated with the target cell, or any combination thereof. In some examples, the medium access control layer parameter may include a scheduling offset parameter other than a cell-specific offset parameter.

At 430, the UE 415 may optionally receive a second set of parameters associated with the source cell. The second set of parameters may indicate at least one of ephemeris information associated with the source cell, a common timing advance associated with the source cell, a medium access control layer parameter associated with the source cell, a cell-specific offset associated with the source cell, or any combination thereof.

At 435, the UE 415 may optionally compare the first set of parameters associated with the target cell to the second set of parameters associated with the source cell. The UE 415 may determine that the target cell and the source cell are served by the same communications device based on the comparing.

At 440, the UE 415 may determine a timing advance value based on the first set of parameters received from the network entity 405. In some examples, the UE 415 may determine a timing value added to an estimated timing advance at the UE based on determining that the target cell is served by the same communications device as the source cell. Additionally or alternatively, the UE 415 may determine a timing value for random access channel transmission based on the target cell being served by the communications device. In some cases, the UE 415 may derive the timing advance value for the target cell using the timing value.

At 445, the UE 415 may transmit an uplink communication in a random access process in accordance with a timing advance value for the target cell. The uplink communication may include a msg1 or msgA of a random access process. In some examples, the UE 415 may derive the timing advance value for the target cell using a timing advance value for the source cell based on the target cell being served by a common communications device as the source cell.

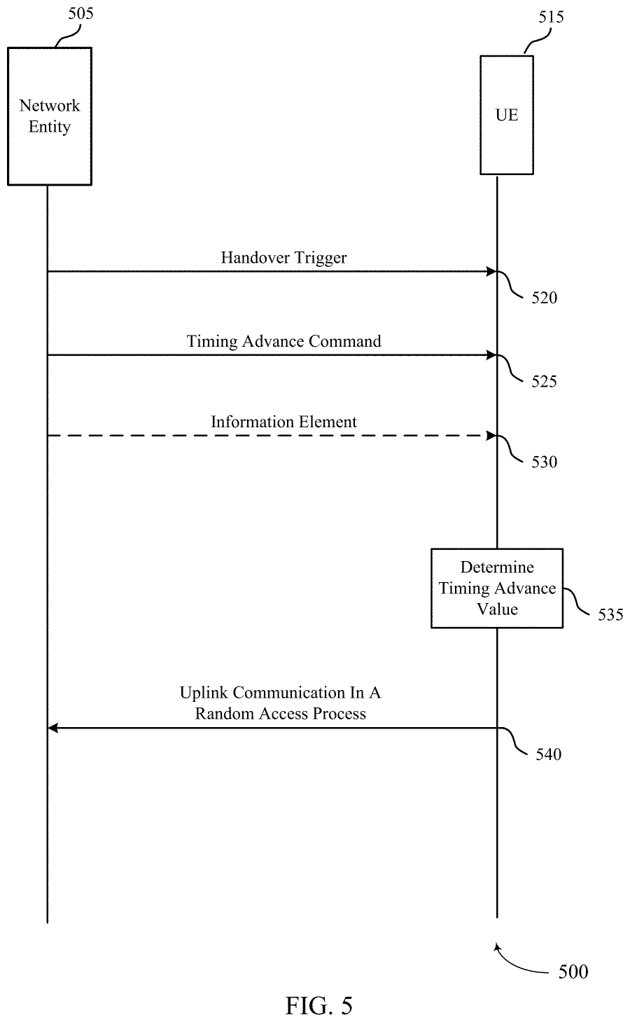

FIG. 5 illustrates an example of a process flow 500 that supports uplink timing management in communications systems in accordance with one or more aspects of the present disclosure. In some examples, the process flow 500 may implement aspects of wireless communications system 100, the wireless communications system 200 and the wireless communications system 300 described with reference to FIGS. 1, 2 and 3, respectively. For example, the process flow 500 may be based on one or more rules for timing advance determination in wireless communications systems. The process flow 500 may be implemented by the UE 515 and a network entity 505 for reduced power consumption, and may promote low latency and low interference for wireless communications, among others. The network entity 505 may include a base station and a communications device (e.g., satellite). The network entity 505 may be an example of a network entity 205 and a network entity 305, as described with reference to FIGS. 2 and 3. The UE 515 may be an example of a UE 115, as described with reference to FIGS. 1, 2 and 3.

In the following description of the process flow 500, the operations between the network entity 505 and the UE 515 may be transmitted in a different order than the example order shown, or the operations performed by the network entity 505 and the UE 515 may be performed in different orders or at different times. Some operations may also be omitted from the process flow 500, and other operations may be added to the process flow 500.

At 520, the UE 515 may receive, at a source cell served by a communications device, signaling that triggers a handover to a target cell. In some examples, the signaling that triggers the handover may include a handover command or a fulfilled conditional handover or both.

At 525, the UE 515 may receive a timing advance command indicating a timing offset associated with the target cell. At 530, the UE 515 may optionally receive an information element indicating that the target cell is served by the communications device. Additionally or alternatively, the UE 515 may receive an information element indicating that the UE 515 uses the timing offset associated with the target cell to derive a timing advance value for the target cell.

At 535, the UE 515 may determine a timing advance value. In some examples, the UE 515 may derive the timing advance value based on the information element received at 530. At 540, the UE 515 may transmit an uplink communication in a random access process in accordance with the timing advance value for the target cell. The uplink communication may include a msg1 or msgA of a random access process. In some examples, the UE 515 may derive the timing advance value for the target cell based on the timing offset.

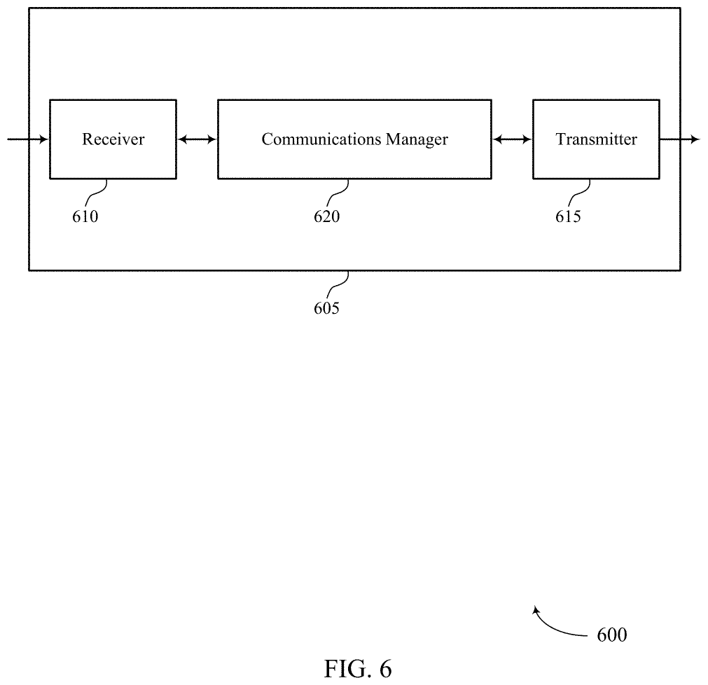

FIG. 6 shows a block diagram 600 of a device 605 that supports uplink timing management in communications systems in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink timing management in communications systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink timing management in communications systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of uplink timing management in communications systems as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, at a source cell served by a network entity (e.g., communications device or satellite), signaling that triggers a handover to a target cell. The communications manager 620 may be configured as or otherwise support a means for receiving a first set of parameters associated with the target cell, the first set of parameters indicating that the target cell is served by the network entity (e.g., communications device or satellite). The communications manager 620 may be configured as or otherwise support a means for transmitting, to the target cell, an uplink communication in accordance with a timing advance value for the target cell, the timing advance value for the target cell derived using a timing advance value for the source cell based on the target cell being served by the network entity (e.g., communications device or satellite).

Additionally or alternatively, the communications manager 620 may support wireless communication at a UE in accordance with examples as disclosed herein. For example, the communications manager 620 may be configured as or otherwise support a means for receiving, at a source cell served by a network entity (e.g., communications device or satellite), signaling that triggers a handover to a target cell. The communications manager 620 may be configured as or otherwise support a means for receiving a timing advance command indicating a timing offset associated with the target cell. The communications manager 620 may be configured as or otherwise support a means for transmitting, to the target cell, an uplink communication in accordance with a timing advance value for the target cell, the timing advance value for the target cell derived based on the timing offset.

By including or configuring the communications manager 620 in accordance with examples as described herein, the device 605 (e.g., a processor controlling or otherwise coupled to the receiver 610, the transmitter 615, the communications manager 620, or a combination thereof) may support techniques reduced processing, reduced power consumption, and more efficient utilization of communication resources.

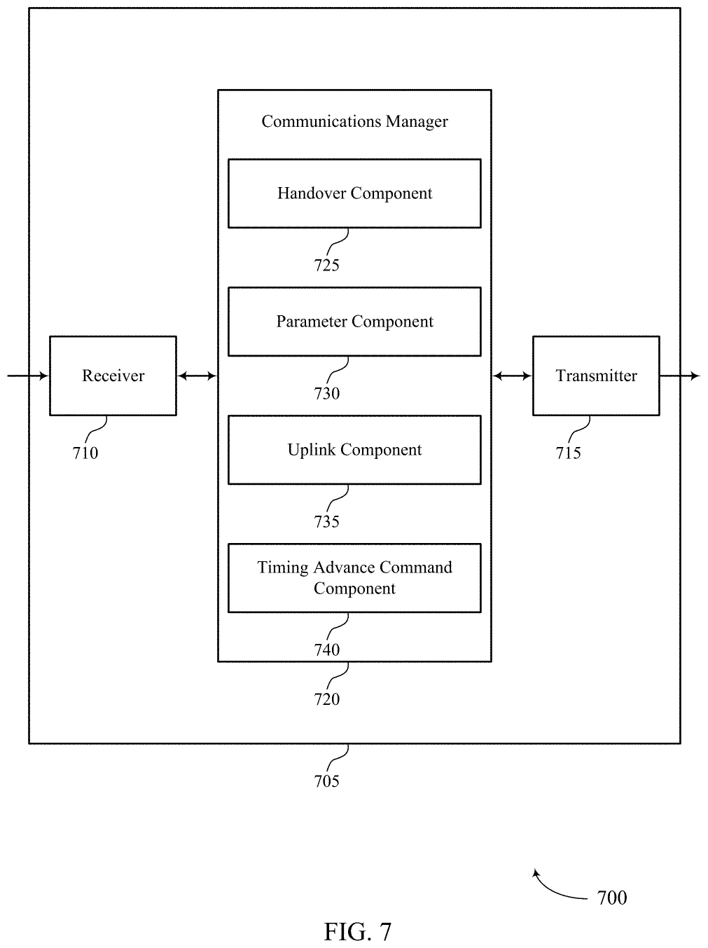

FIG. 7 shows a block diagram 700 of a device 705 that supports uplink timing management in communications systems in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink timing management in communications systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink timing management in communications systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink timing management in communications systems as described herein. For example, the communications manager 720 may include a handover component 725, a parameter component 730, an uplink component 735, a timing advance command component 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The handover component 725 may be configured as or otherwise support a means for receiving, at a source cell served by a network entity (e.g., communications device or satellite), signaling that triggers a handover to a target cell. The parameter component 730 may be configured as or otherwise support a means for receiving a first set of parameters associated with the target cell, the first set of parameters indicating that the target cell is served by the network entity (e.g., communications device or satellite). The uplink component 735 may be configured as or otherwise support a means for transmitting, to the target cell, an uplink communication in accordance with a timing advance value for the target cell, the timing advance value for the target cell derived using a timing advance value for the source cell based on the target cell being served by the network entity (e.g., communications device or satellite).

Additionally or alternatively, the communications manager 720 may support wireless communication at a UE in accordance with examples as disclosed herein. The handover component 725 may be configured as or otherwise support a means for receiving, at a source cell served by a network entity (e.g., communications device or satellite), signaling that triggers a handover to a target cell. The timing advance command component 740 may be configured as or otherwise support a means for receiving a timing advance command indicating a timing offset associated with the target cell. The uplink component 735 may be configured as or otherwise support a means for transmitting, to the target cell, an uplink communication in accordance with a timing advance value for the target cell, the timing advance value for the target cell derived based on the timing offset.

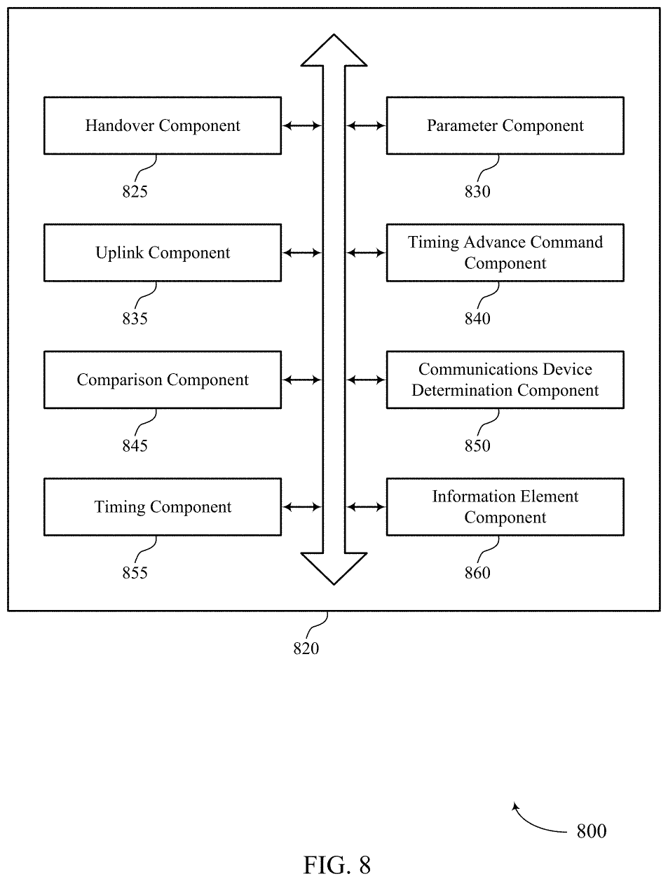

FIG. 8 shows a block diagram 800 of a communications manager 820 that supports uplink timing management in communications systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink timing management in communications systems as described herein. For example, the communications manager 820 may include a handover component 825, a parameter component 830, an uplink component 835, a timing advance command component 840, a comparison component 845, a communications device determination component 850, a timing component 855, an information element component 860, or any combination thereof. Each of these components may communicate, directly or indirectly, with one another (e.g., via one or more buses).

The communications manager 820 may support wireless communication at a UE in accordance with examples as disclosed herein. The handover component 825 may be configured as or otherwise support a means for receiving, at a source cell served by a network entity (e.g., communications device or satellite), signaling that triggers a handover to a target cell. The parameter component 830 may be configured as or otherwise support a means for receiving a first set of parameters associated with the target cell, the first set of parameters indicating that the target cell is served by the network entity (e.g., communications device or satellite). The uplink component 835 may be configured as or otherwise support a means for transmitting, to the target cell, an uplink communication in accordance with a timing advance value for the target cell, the timing advance value for the target cell derived using a timing advance value for the source cell based on the target cell being served by the network entity (e.g., communications device or satellite).

In some examples, the parameter component 830 may be configured as or otherwise support a means for receiving a second set of parameters associated with the source cell. In some examples, the comparison component 845 may be configured as or otherwise support a means for comparing the first set of parameters associated with the target cell to the second set of parameters associated with the source cell. In some examples, the communications device determination component 850 may be configured as or otherwise support a means for determining the network entity to serve the target cell based on the comparing.

In some examples, the parameter component 830 may be configured as or otherwise support a means for receiving, via a system information block, the first set of parameters including an identifier of the network entity (e.g., identifier of a communications device). In some examples, the communications device determination component 850 may be configured as or otherwise support a means for determining the network entity to serve the target cell based on the identifier.

In some examples, the timing component 855 may be configured as or otherwise support a means for determining a timing value added to an estimated timing advance at the UE based on the target cell being served by the network entity (e.g., communications device), the timing advance value for the target cell derived using the timing value. In some examples, the timing component 855 may be configured as or otherwise support a means for determining a timing value for random access channel transmission based on the target cell being served by the network entity (e.g., communications device), the timing advance value for the target cell derived using the timing value.

In some examples, the parameter component 830 may be configured as or otherwise support a means for receiving, from the target cell, a system information block including the first set of parameters associated with the target cell. In some examples, the parameter component 830 may be configured as or otherwise support a means for receiving, from the source cell, the first set of parameters associated with the target cell.

In some examples, the handover component 825 may be configured as or otherwise support a means for performing the handover to the target cell based on transmitting the uplink communication. In some examples, the first set of parameters includes at least one of ephemeris information, a common timing advance, a medium access control layer parameter, a cell-specific offset, or any combination thereof.

In some examples, medium access control layer parameter includes a scheduling offset parameter other than a cell-specific offset parameter. In some examples, the signaling that triggers the handover includes a handover command or a fulfilled conditional handover or both.

Additionally or alternatively, the communications manager 820 may support wireless communication at a UE in accordance with examples as disclosed herein. In some examples, the handover component 825 may be configured as or otherwise support a means for receiving, at a source cell served by a network entity (e.g., communications device or satellite), signaling that triggers a handover to a target cell. The timing advance command component 840 may be configured as or otherwise support a means for receiving a timing advance command indicating a timing offset associated with the target cell. In some examples, the uplink component 835 may be configured as or otherwise support a means for transmitting, to the target cell, an uplink communication in accordance with a timing advance value for the target cell, the timing advance value for the target cell derived based on the timing offset.

In some examples, the information element component 860 may be configured as or otherwise support a means for receiving an information element indicating that the target cell is served by the network entity (e.g., communications device or satellite), the timing advance value derived based on the information element. In some examples, the information element component 860 may be configured as or otherwise support a means for receiving an information element indicating that the UE uses the timing offset associated with the target cell to derive the timing advance value for the target cell.

In some examples, the timing advance command component 840 may be configured as or otherwise support a means for determining that the timing advance command includes a valid timing advance command value. In some examples, the communications device determination component 850 may be configured as or otherwise support a means for determining that the target cell is served by the network entity based on the timing advance command including the valid timing advance command value.

In some examples, the handover component 825 may be configured as or otherwise support a means for performing the handover to the target cell based on transmitting the uplink communication. In some examples, the signaling that triggers the handover includes the timing advance command or an information element or both. In some examples, the signaling that triggers the handover includes a handover command or a fulfilled conditional handover or both.

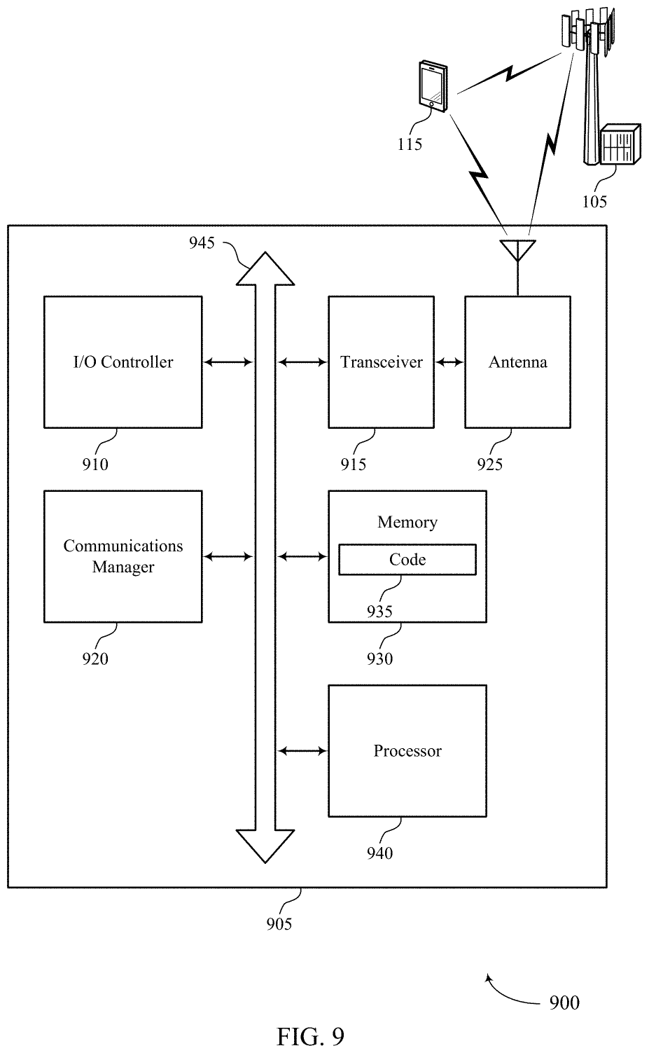

FIG. 9 shows a diagram of a system 900 including a device 905 that supports uplink timing management in communications systems in accordance with one or more aspects of the present disclosure. The device 905 may be an example of or include the components of a device 605, a device 705, or a UE 115 as described herein. The device 905 may communicate wirelessly with one or more network entities 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting uplink timing management in communications systems). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, at a source cell served by a network entity (e.g., communications device or satellite), signaling that triggers a handover to a target cell. The communications manager 920 may be configured as or otherwise support a means for receiving a first set of parameters associated with the target cell, the first set of parameters indicating that the target cell is served by the network entity (e.g., communications device or satellite). The communications manager 920 may be configured as or otherwise support a means for transmitting, to the target cell, an uplink communication in accordance with a timing advance value for the target cell, the timing advance value for the target cell derived using a timing advance value for the source cell based on the target cell being served by the network entity (e.g., communications device or satellite).

Additionally or alternatively, the communications manager 920 may support wireless communication at a UE in accordance with examples as disclosed herein. For example, the communications manager 920 may be configured as or otherwise support a means for receiving, at a source cell served by a network entity (e.g., communications device or satellite), signaling that triggers a handover to a target cell. The communications manager 920 may be configured as or otherwise support a means for receiving a timing advance command indicating a timing offset associated with the target cell. The communications manager 920 may be configured as or otherwise support a means for transmitting, to the target cell, an uplink communication in accordance with a timing advance value for the target cell, the timing advance value for the target cell derived based on the timing offset.

By including or configuring the communications manager 920 in accordance with examples as described herein, the device 905 may support techniques for enhanced communication reliability, reduced latency, enhanced user experience related to reduced processing, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of uplink timing management in communications systems as described herein, or the processor 940 and the memory 930 may be otherwise configured to perform or support such operations.

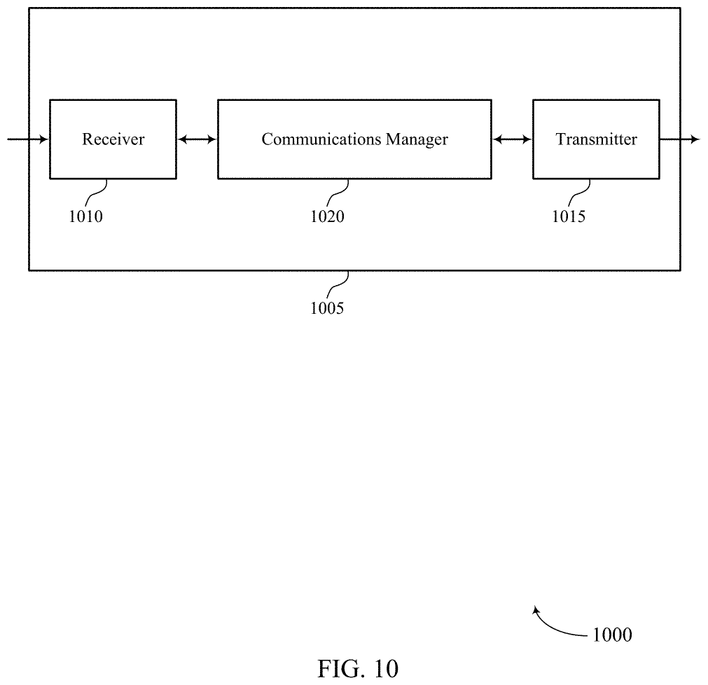

FIG. 10 shows a block diagram 1000 of a device 1005 that supports uplink timing management in communications systems in accordance with one or more aspects of the present disclosure. The device 1005 may be an example of aspects of a network entity as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to uplink timing management in communications systems). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to uplink timing management in communications systems). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of uplink timing management in communications systems as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network entity in accordance with examples as disclosed herein. For example, the communications manager 1020 may be configured as or otherwise support a means for outputting signaling that triggers a handover from a source cell to a target cell. The communications manager 1020 may be configured as or otherwise support a means for outputting a first set of parameters associated with the target cell. The communications manager 1020 may be configured as or otherwise support a means for obtaining an uplink communication in accordance with a timing advance value for the target cell, the timing advance value for the target cell derived using a timing advance value for the source cell.

Additionally or alternatively, the communications manager 1020 may support wireless communication at a network entity in accordance with examples as disclosed herein. For example, the communications manager 1020 may be configured as or otherwise support a means for outputting signaling that triggers a handover from a source cell to a target cell. The communications manager 1020 may be configured as or otherwise support a means for outputting a timing advance command indicating a timing offset associated with the target cell. The communications manager 1020 may be configured as or otherwise support a means for obtaining an uplink communication in accordance with a timing advance value for the target cell, the timing advance value for the target cell being based on the timing offset.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, and more efficient utilization of communication resources.

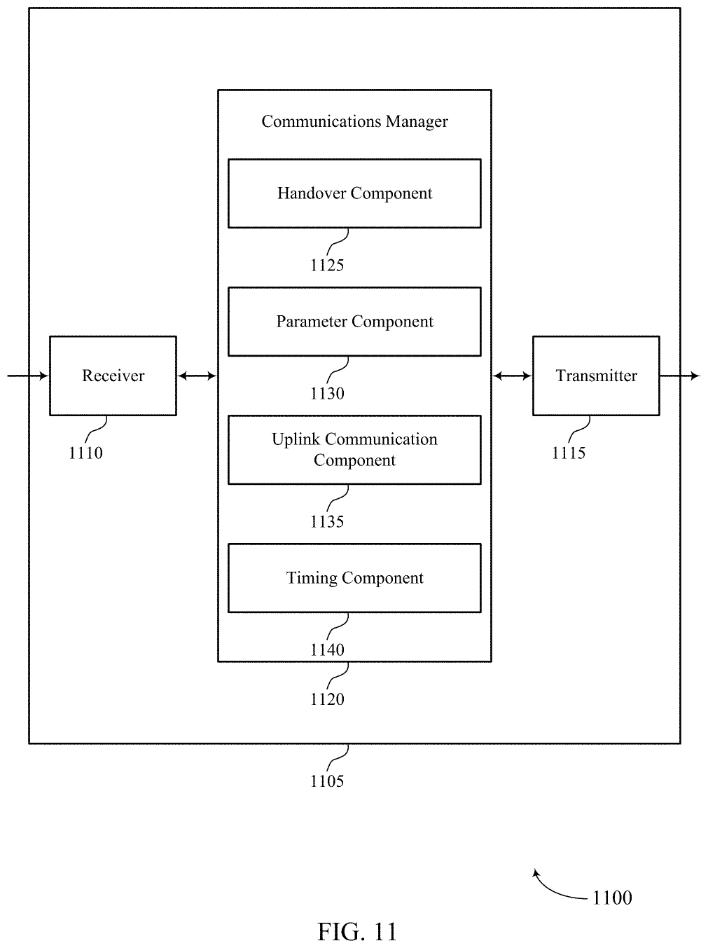

FIG. 11 shows a block diagram 1100 of a device 1105 that supports uplink timing management in communications systems in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to uplink timing management in communications systems). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to uplink timing management in communications systems). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of uplink timing management in communications systems as described herein. For example, the communications manager 1120 may include a handover component 1125, a parameter component 1130, an uplink communication component 1135, a timing component 1140, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a network entity in accordance with examples as disclosed herein. The handover component 1125 may be configured as or otherwise support a means for outputting signaling that triggers a handover from a source cell to a target cell. The parameter component 1130 may be configured as or otherwise support a means for outputting a first set of parameters associated with the target cell. The uplink communication component 1135 may be configured as or otherwise support a means for obtaining an uplink communication in accordance with a timing advance value for the target cell, the timing advance value for the target cell derived using a timing advance value for the source cell.

Additionally or alternatively, the communications manager 1120 may support wireless communication at a network entity in accordance with examples as disclosed herein. The handover component 1125 may be configured as or otherwise support a means for outputting signaling that triggers a handover from a source cell to a target cell. The timing component 1140 may be configured as or otherwise support a means for outputting a timing advance command indicating a timing offset associated with the target cell. The uplink communication component 1135 may be configured as or otherwise support a means for obtaining an uplink communication in accordance with a timing advance value for the target cell, the timing advance value for the target cell being based on the timing offset.

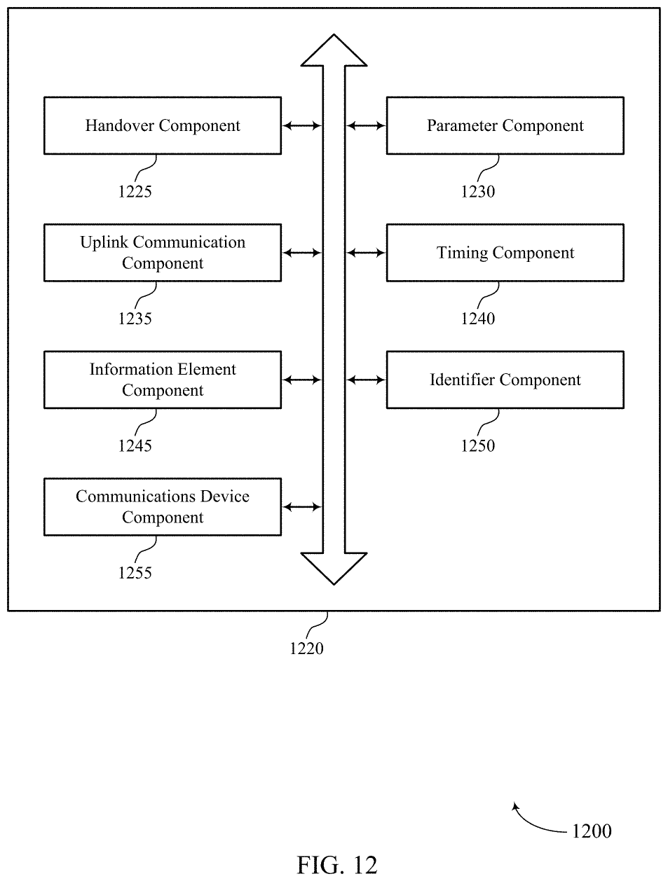

FIG. 12 shows a block diagram 1200 of a communications manager 1220 that supports uplink timing management in communications systems in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink timing management in communications systems as described herein. For example, the communications manager 1220 may include a handover component 1225, a parameter component 1230, an uplink communication component 1235, a timing component 1240, an information element component 1245, an identifier component 1250, a communications device component 1255, or any combination thereof. Each of these components may communicate, directly or indirectly, with one another (e.g., via one or more buses).

The communications manager 1220 may support wireless communication at a network entity in accordance with examples as disclosed herein. The handover component 1225 may be configured as or otherwise support a means for outputting signaling that triggers a handover from a source cell to a target cell. The parameter component 1230 may be configured as or otherwise support a means for outputting a first set of parameters associated with the target cell. The uplink communication component 1235 may be configured as or otherwise support a means for obtaining an uplink communication in accordance with a timing advance value for the target cell, the timing advance value for the target cell derived using a timing advance value for the source cell. In some examples, the first set of parameters indicates that the source cell and the target cell are served by the network entity (e.g., communications device or satellite).

In some examples, the identifier component 1250 may be configured as or otherwise support a means for outputting an identifier of the network entity (e.g., identifier of a communications device). In some examples, the communications device component 1255 may be configured as or otherwise support a means for determining the network entity serving the target cell based on the identifier.

In some examples, the timing component 1240 may be configured as or otherwise support a means for determining a timing value for an estimated timing advance based on the source cell and the target cell being served by the network entity (e.g., communications device or satellite), the timing advance value for the target cell being based on the timing value. In some examples, the timing component 1240 may be configured as or otherwise support a means for determining a timing value for random access channel transmission based on the source cell and the target cell being served by the network entity, the timing advance value for the target cell being based on the timing value.

In some examples, the parameter component 1230 may be configured as or otherwise support a means for outputting a system information block including the first set of parameters associated with the target cell. In some examples, the first set of parameters includes at least one of ephemeris information, a common timing advance, a medium access control layer parameter, a cell-specific offset, or any combination thereof.

In some examples, medium access control layer parameter includes a scheduling offset parameter other than a cell-specific offset parameter. In some examples, the signaling that triggers the handover includes a handover command or a fulfilled conditional handover or both.

Additionally or alternatively, the communications manager 1220 may support wireless communication at a network entity in accordance with examples as disclosed herein. In some examples, the handover component 1225 may be configured as or otherwise support a means for outputting signaling that triggers a handover from a source cell to a target cell. The timing component 1240 may be configured as or otherwise support a means for outputting a timing advance command indicating a timing offset associated with the target cell. In some examples, the uplink communication component 1235 may be configured as or otherwise support a means for obtaining an uplink communication in accordance with a timing advance value for the target cell, the timing advance value for the target cell being based on the timing offset.

In some examples, the information element component 1245 may be configured as or otherwise support a means for outputting an information element indicating that the target cell is served by a network entity. In some examples, the information element component 1245 may be configured as or otherwise support a means for outputting an information element indicating that the timing advance value is based on the timing offset associated with the target cell.

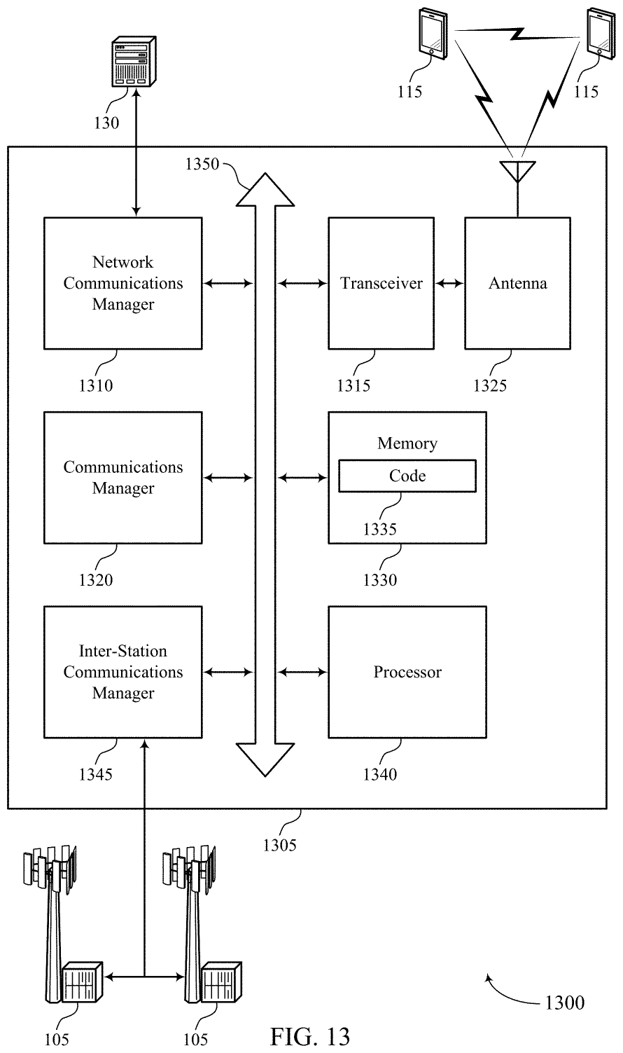

FIG. 13 shows a diagram of a system 1300 including a device 1305 that supports uplink timing management in communications systems in accordance with one or more aspects of the present disclosure. The device 1305 may be an example of or include the components of a device 1005, a device 1105, or a network entity as described herein. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting uplink timing management in communications systems). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 143, and may include a controller or scheduler for controlling communications with UEs 115 in cooperation with other base stations 143. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 143.

The communications manager 1320 may support wireless communication at a network entity in accordance with examples as disclosed herein. For example, the communications manager 1320 may be configured as or otherwise support a means for outputting signaling that triggers a handover from a source cell to a target cell. The communications manager 1320 may be configured as or otherwise support a means for outputting a first set of parameters associated with the target cell. The communications manager 1320 may be configured as or otherwise support a means for obtaining an uplink communication in accordance with a timing advance value for the target cell, the timing advance value for the target cell derived using a timing advance value for the source cell.

Additionally or alternatively, the communications manager 1320 may support wireless communication at a network entity in accordance with examples as disclosed herein. For example, the communications manager 1320 may be configured as or otherwise support a means for outputting signaling that triggers a handover from a source cell to a target cell. The communications manager 1320 may be configured as or otherwise support a means for outputting a timing advance command indicating a timing offset associated with the target cell. The communications manager 1320 may be configured as or otherwise support a means for obtaining an uplink communication in accordance with a timing advance value for the target cell, the timing advance value for the target cell being based on the timing offset.

By including or configuring the communications manager 1320 in accordance with examples as described herein, the device 1305 may support techniques for communication reliability, reduced latency, user experience related to reduced processing, and more efficient utilization of communication resources.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of uplink timing management in communications systems as described herein, or the processor 1340 and the memory 1330 may be otherwise configured to perform or support such operations.

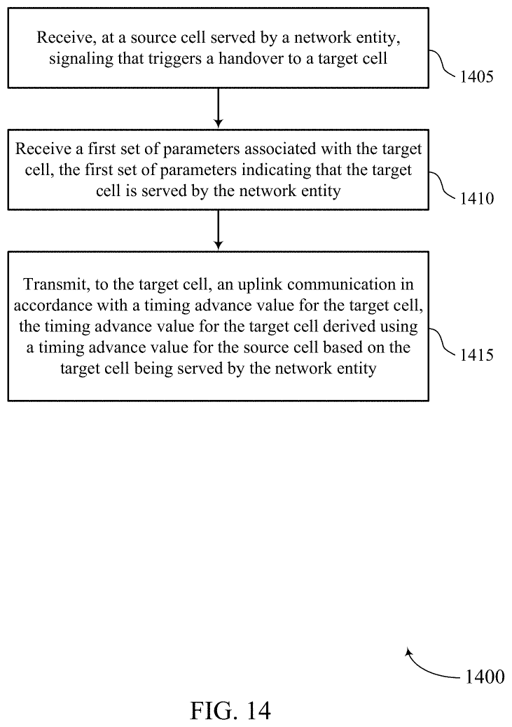

FIG. 14 shows a flowchart illustrating a method 1400 that supports uplink timing management in communications systems in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, at a source cell served by a network entity (e.g., communications device), signaling that triggers a handover to a target cell. The operations of 1405 may be performed in accordance with examples as disclosed herein. In some examples, aspects of the operations of 1405 may be performed by a handover component 825 as described with reference to FIG. 8.

At 1410, the method may include receiving a first set of parameters associated with the target cell, the first set of parameters indicating that the target cell is served by the network entity (e.g., communications device). The operations of 1410 may be performed in accordance with examples as disclosed herein. In some examples, aspects of the operations of 1410 may be performed by a parameter component 830 as described with reference to FIG. 8.

At 1415, the method may include transmitting, to the target cell, an uplink communication in accordance with a timing advance value for the target cell, the timing advance value for the target cell derived using a timing advance value for the source cell based on the target cell being served by the network entity (e.g., communications device). The operations of 1415 may be performed in accordance with examples as disclosed herein. In some examples, aspects of the operations of 1415 may be performed by an uplink component 835 as described with reference to FIG. 8.

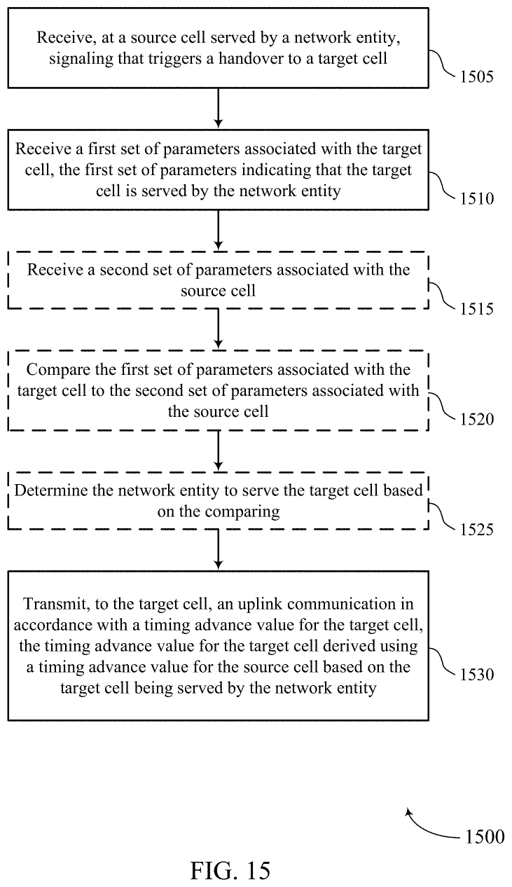

FIG. 15 shows a flowchart illustrating a method 1500 that supports uplink timing management in communications systems in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, at a source cell served by a network entity (e.g., communications device), signaling that triggers a handover to a target cell. The operations of 1505 may be performed in accordance with examples as disclosed herein. In some examples, aspects of the operations of 1505 may be performed by a handover component 825 as described with reference to FIG. 8.

At 1510, the method may include receiving a first set of parameters associated with the target cell, the first set of parameters indicating that the target cell is served by the network entity (e.g., communications device). The operations of 1510 may be performed in accordance with examples as disclosed herein. In some examples, aspects of the operations of 1510 may be performed by a parameter component 830 as described with reference to FIG. 8.

At 1515, the method may optionally include receiving a second set of parameters associated with the source cell. The operations of 1515 may be performed in accordance with examples as disclosed herein. In some examples, aspects of the operations of 1515 may be performed by a parameter component 830 as described with reference to FIG. 8.

At 1520, the method may optionally include comparing the first set of parameters associated with the target cell to the second set of parameters associated with the source cell. The operations of 1520 may be performed in accordance with examples as disclosed herein. In some examples, aspects of the operations of 1520 may be performed by a comparison component 845 as described with reference to FIG. 8.

At 1525, the method may optionally include determining the network entity (e.g., communications device) to serve the target cell based on the comparing. The operations of 1525 may be performed in accordance with examples as disclosed herein. In some examples, aspects of the operations of 1525 may be performed by a communications device determination component 850 as described with reference to FIG. 8.

At 1530, the method may include transmitting, to the target cell, an uplink communication in accordance with a timing advance value for the target cell, the timing advance value for the target cell derived using a timing advance value for the source cell based on the target cell being served by the network entity (e.g., communications device). The operations of 1530 may be performed in accordance with examples as disclosed herein. In some examples, aspects of the operations of 1530 may be performed by an uplink component 835 as described with reference to FIG. 8.

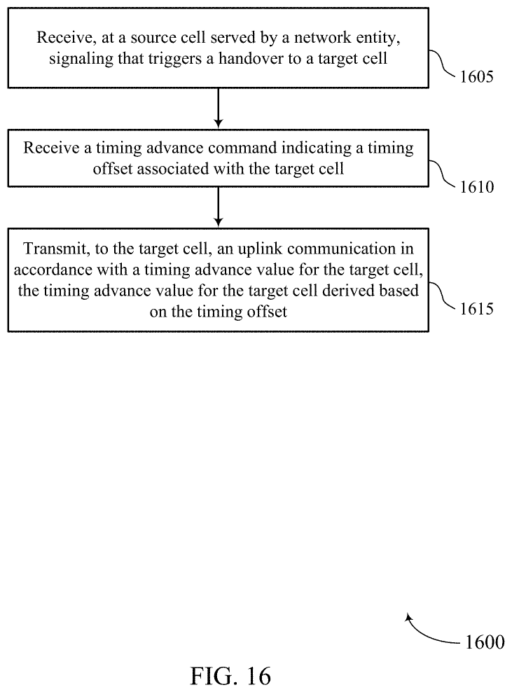

FIG. 16 shows a flowchart illustrating a method 1600 that supports uplink timing management in communications systems in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving, at a source cell served by a network entity (e.g., communications device or satellite), signaling that triggers a handover to a target cell. The operations of 1605 may be performed in accordance with examples as disclosed herein. In some examples, aspects of the operations of 1605 may be performed by a handover component 825 as described with reference to FIG. 8.

At 1610, the method may include receiving a timing advance command indicating a timing offset associated with the target cell. The operations of 1610 may be performed in accordance with examples as disclosed herein. In some examples, aspects of the operations of 1610 may be performed by a timing advance command component 840 as described with reference to FIG. 8.

At 1615, the method may include transmitting, to the target cell, an uplink communication in accordance with a timing advance value for the target cell, the timing advance value for the target cell derived based on the timing offset. The operations of 1615 may be performed in accordance with examples as disclosed herein. In some examples, aspects of the operations of 1615 may be performed by an uplink component 835 as described with reference to FIG. 8.

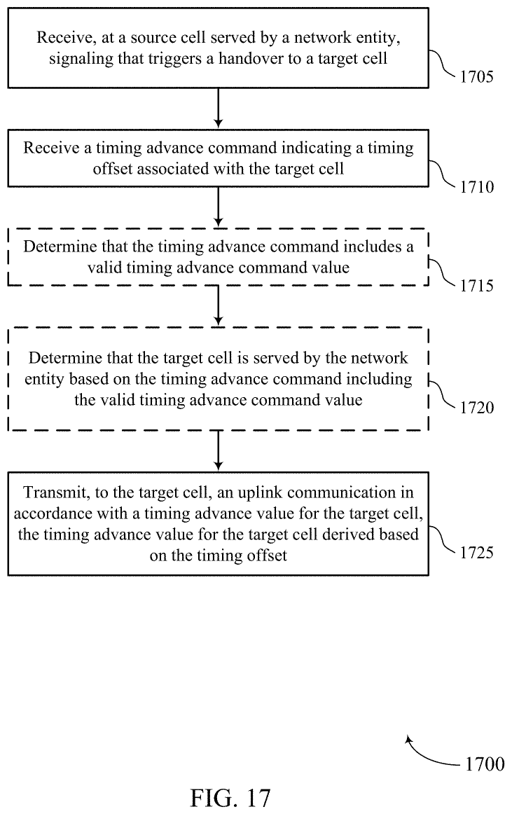

FIG. 17 shows a flowchart illustrating a method 1700 that supports uplink timing management in communications systems in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include receiving, at a source cell served by a network entity (e.g., communications device or satellite), signaling that triggers a handover to a target cell. The operations of 1705 may be performed in accordance with examples as disclosed herein. In some examples, aspects of the operations of 1705 may be performed by a handover component 825 as described with reference to FIG. 8.

At 1710, the method may include receiving a timing advance command indicating a timing offset associated with the target cell. The operations of 1710 may be performed in accordance with examples as disclosed herein. In some examples, aspects of the operations of 1710 may be performed by a timing advance command component 840 as described with reference to FIG. 8.

At 1715, the method may optionally include determining that the timing advance command includes a valid timing advance command value. The operations of 1715 may be performed in accordance with examples as disclosed herein. In some examples, aspects of the operations of 1715 may be performed by a timing advance command component 840 as described with reference to FIG. 8.

At 1720, the method may optionally include determining that the target cell is served by the network entity based on the timing advance command including the valid timing advance command value. The operations of 1720 may be performed in accordance with examples as disclosed herein. In some examples, aspects of the operations of 1720 may be performed by a communications device determination component 850 as described with reference to FIG. 8.

At 1725, the method may include transmitting, to the target cell, an uplink communication in accordance with a timing advance value for the target cell, the timing advance value for the target cell derived based on the timing offset. The operations of 1725 may be performed in accordance with examples as disclosed herein. In some examples, aspects of the operations of 1725 may be performed by an uplink component 835 as described with reference to FIG. 8.

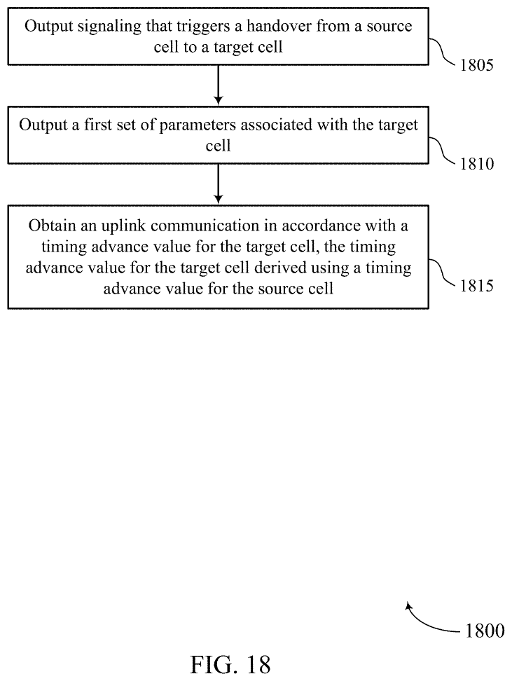

FIG. 18 shows a flowchart illustrating a method 1800 that supports uplink timing management in communications systems in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1805, the method may include outputting signaling that triggers a handover from a source cell to a target cell. The operations of 1805 may be performed in accordance with examples as disclosed herein. In some examples, aspects of the operations of 1805 may be performed by a handover component 1225 as described with reference to FIG. 12.

At 1810, the method may include outputting a first set of parameters associated with the target cell. The operations of 1810 may be performed in accordance with examples as disclosed herein. In some examples, aspects of the operations of 1810 may be performed by a parameter component 1230 as described with reference to FIG. 12.

At 1815, the method may include obtaining an uplink communication in accordance with a timing advance value for the target cell, the timing advance value for the target cell derived using a timing advance value for the source cell. The operations of 1815 may be performed in accordance with examples as disclosed herein. In some examples, aspects of the operations of 1815 may be performed by an uplink communication component 1235 as described with reference to FIG. 12.

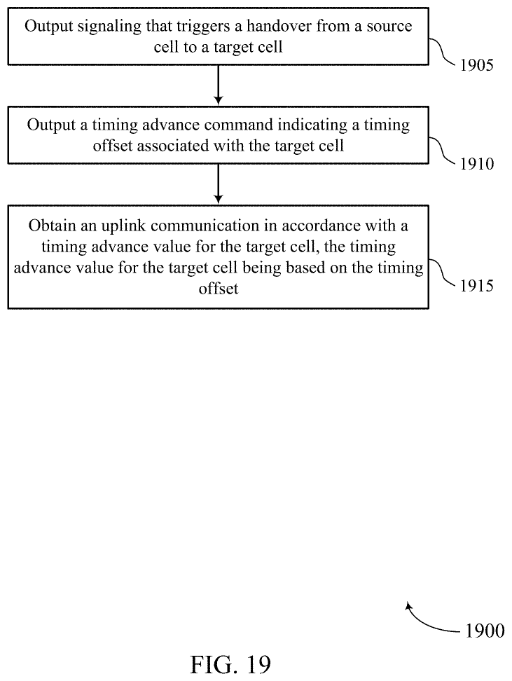

FIG. 19 shows a flowchart illustrating a method 1900 that supports uplink timing management in communications systems in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1905, the method may include outputting signaling that triggers a handover from a source cell to a target cell. The operations of 1905 may be performed in accordance with examples as disclosed herein. In some examples, aspects of the operations of 1905 may be performed by a handover component 1225 as described with reference to FIG. 12.

At 1910, the method may include outputting a timing advance command indicating a timing offset associated with the target cell. The operations of 1910 may be performed in accordance with examples as disclosed herein. In some examples, aspects of the operations of 1910 may be performed by a timing component 1240 as described with reference to FIG. 12.

At 1915, the method may include obtaining an uplink communication in accordance with a timing advance value for the target cell, the timing advance value for the target cell being based on the timing offset. The operations of 1915 may be performed in accordance with examples as disclosed herein. In some examples, aspects of the operations of 1915 may be performed by an uplink communication component 1235 as described with reference to FIG. 12.

The following provides an overview of aspects of the present disclosure:

Aspect 1: A method for wireless communication at a UE, comprising: receiving, at a source cell served by a network entity, signaling that triggers a handover to a target cell; receiving a first set of parameters associated with the target cell, the first set of parameters indicating that the target cell is served by the network entity; and transmitting, to the target cell, an uplink communication in accordance with a timing advance value for the target cell, the timing advance value for the target cell derived using a timing advance value for the source cell based at least in part on the target cell being served by the network entity.

Aspect 2: The method of aspect 1, further comprising: receiving a second set of parameters associated with the source cell; and comparing the first set of parameters associated with the target cell to the second set of parameters associated with the source cell; and determining the network entity to serve the target cell based at least in part on the comparing.

Aspect 3: The method of any of aspects 1 through 2, further comprising: receiving, via a system information block, the first set of parameters comprising an identifier of the network entity; and determining the network entity to serve the target cell based at least in part on the identifier.

Aspect 4: The method of any of aspects 1 through 3, further comprising: determining a timing value added to an estimated timing advance at the UE based at least in part on the target cell being served by the network entity, the timing advance value for the target cell derived using the timing value.

Aspect 5: The method of any of aspects 1 through 4, further comprising: determining a timing value for random access channel transmission based at least in part on the target cell being served by the network entity, the timing advance value for the target cell derived using the timing value.

Aspect 6: The method of any of aspects 1 through 5, the receiving the first set of parameters comprising: receiving, from the target cell, a system information block comprising the first set of parameters associated with the target cell.

Aspect 7: The method of any of aspects 1 through 6, the receiving the first set of parameters comprising: receiving, from the source cell, the first set of parameters associated with the target cell.

Aspect 8: The method of any of aspects 1 through 7, further comprising: performing the handover to the target cell based at least in part on transmitting the uplink communication.

Aspect 9: The method of any of aspects 1 through 8, wherein the first set of parameters comprises at least one of ephemeris information, a common timing advance, a media access layer parameter, a cell-specific offset, or any combination thereof.

Aspect 10: The method of aspect 9, wherein media access layer parameter comprises a scheduling offset parameter other than a cell-specific offset parameter.

Aspect 11: The method of any of aspects 1 through 10, wherein the signaling that triggers the handover comprises a handover command or a fulfilled conditional handover or both.

Aspect 12: A method for wireless communication at a UE, comprising: receiving, at a source cell served by a network entity, signaling that triggers a handover to a target cell; receiving a timing advance command indicating a timing offset associated with the target cell; and transmitting, to the target cell, an uplink communication in accordance with a timing advance value for the target cell, the timing advance value for the target cell derived based at least in part on the timing offset.

Aspect 13: The method of aspect 12, further comprising: receiving an information element indicating that the target cell is served by the network entity, the timing advance value derived based at least in part on the information element.

Aspect 14: The method of any of aspects 12 through 13, further comprising: receiving an information element indicating that the UE uses the timing offset associated with the target cell to derive the timing advance value for the target cell.

Aspect 15: The method of any of aspects 12 through 14, further comprising: determining that the timing advance command comprises a valid timing advance command value; and determining that the target cell is served by the network entity based at least in part on the timing advance command comprising the valid timing advance command value.

Aspect 16: The method of any of aspects 12 through 15, further comprising: performing the handover to the target cell based at least in part on transmitting the uplink communication.

Aspect 17: The method of any of aspects 12 through 16, wherein the signaling that triggers the handover comprises the timing advance command or an information element or both.

Aspect 18: The method of any of aspects 12 through 17, wherein the signaling that triggers the handover comprises a handover command or a fulfilled conditional handover or both.

Aspect 19: A method for wireless communication at a network entity, comprising: outputting signaling that triggers a handover from a source cell to a target cell; outputting a first set of parameters associated with the target cell; and obtaining an uplink communication in accordance with a timing advance value for the target cell, the timing advance value for the target cell derived using a timing advance value for the source cell.

Aspect 20: The method of aspect 19, wherein the first set of parameters indicates that the source cell and the target cell are served by the network entity.

Aspect 21: The method of aspect 20, further comprising: outputting an identifier of the network entity; and determining the network entity serving the target cell based at least in part on the identifier.

Aspect 22: The method of any of aspects 19 through 21, further comprising: determining a timing value for an estimated timing advance based at least in part on the source cell and the target cell being served by the network entity, the timing advance value for the target cell being based at least in part on the timing value.

Aspect 23: The method of any of aspects 19 through 22, further comprising: determining a timing value for random access channel transmission based at least in part on the source cell and the target cell being served by the network entity, the timing advance value for the target cell being based at least in part on the timing value.

Aspect 24: The method of any of aspects 19 through 23, the outputting the first set of parameters comprising: outputting a system information block comprising the first set of parameters associated with the target cell.

Aspect 25: The method of any of aspects 19 through 24, wherein the first set of parameters comprises at least one of ephemeris information, a common timing advance, a media access layer parameter, a cell-specific offset, or any combination thereof.

Aspect 26: The method of aspect 25, wherein media access layer parameter comprises a scheduling offset parameter other than a cell-specific offset parameter.

Aspect 27: The method of any of aspects 19 through 26, wherein the signaling that triggers the handover comprises a handover command or a fulfilled conditional handover or both.

Aspect 28: A method for wireless communication at a network entity, comprising: outputting signaling that triggers a handover from a source cell to a target cell; outputting a timing advance command indicating a timing offset associated with the target cell; and obtaining an uplink communication in accordance with a timing advance value for the target cell, the timing advance value for the target cell being based at least in part on the timing offset.

Aspect 29: The method of aspect 28, further comprising: outputting an information element indicating that the target cell is served by the network entity.

Aspect 30: The method of any of aspects 28 through 29, further comprising: outputting an information element indicating that the timing advance value is based at least in part on the timing offset associated with the target cell.

Aspect 31: A method for wireless communication at a UE, comprising: obtaining, at a source cell served by a network entity, signaling that triggers a handover to a target cell; obtaining a first set of parameters associated with the target cell, the first set of parameters indicating that the target cell is served by the network entity; and generating, to the target cell, an uplink communication in accordance with a timing advance value for the target cell, the timing advance value for the target cell derived using a timing advance value for the source cell based at least in part on the target cell being served by the network entity.

Aspect 32: A method for wireless communication at a UE, comprising: obtaining, at a source cell served by a network entity, signaling that triggers a handover to a target cell; obtaining a timing advance command indicating a timing offset associated with the target cell; and generating, to the target cell, an uplink communication in accordance with a timing advance value for the target cell, the timing advance value for the target cell derived based at least in part on the timing offset.

Aspect 33: An apparatus for wireless communication at a UE, comprising a processor; memory coupled with the processor, the processor configured to perform a method of any of aspects 1 through 11.

Aspect 34: An apparatus for wireless communication at a UE, comprising at least one means for performing a method of any of aspects 1 through 11.

Aspect 35: A non-transitory computer-readable medium storing code for wireless communication at a UE, the code comprising instructions executable by a processor to perform a method of any of aspects 1 through 11.

Aspect 36: An apparatus for wireless communication at a UE, comprising a processor; memory coupled with the processor, the processor configured to perform a method of any of aspects 12 through 18.

Aspect 37: An apparatus for wireless communication at a UE, comprising at least one means for performing a method of any of aspects 12 through 18.

Aspect 38: A non-transitory computer-readable medium storing code for wireless communication at a UE, the code comprising instructions executable by a processor to perform a method of any of aspects 12 through 18.

Aspect 39: An apparatus for wireless communication at a network entity, comprising a processor; memory coupled with the processor, the processor configured to perform a method of any of aspects 19 through 27.

Aspect 40: An apparatus for wireless communication at a network entity, comprising a processor; memory coupled with the processor; the processor configured to output signaling that triggers a handover from a source cell to a target cell; output a first set of parameters associated with the target cell; and obtain a communication in accordance with a timing advance value for the target cell, the timing advance value for the target cell derived using a timing advance value for the source cell.

Aspect 41: An apparatus for wireless communication at a network entity, comprising at least one means for performing a method of any of aspects 19 through 27.

Aspect 42: A non-transitory computer-readable medium storing code for wireless communication at a network entity, the code comprising instructions executable by a processor to perform a method of any of aspects 19 through 27.

Aspect 43: An apparatus for wireless communication at a network entity, comprising a processor; memory coupled with the processor, the processor configured to cause the apparatus to perform a method of any of aspects 28 through 30.

Aspect 44: An apparatus for wireless communication at a network entity, comprising at least one means for performing a method of any of aspects 28 through 30.

Aspect 45: A non-transitory computer-readable medium storing code for wireless communication at a network entity, the code comprising instructions executable by a processor to perform a method of any of aspects 28 through 30.

Aspect 46: An apparatus for wireless communication at a UE, comprising a processor; memory coupled with the processor, the processor configured to perform a method of aspect 31.

Aspect 47: An apparatus for wireless communication at a UE, comprising at least one means for performing a method of aspect 31.

Aspect 48: A non-transitory computer-readable medium storing code for wireless communication at a UE, the code comprising instructions executable by a processor to perform a method of aspect 31.

Aspect 49: An apparatus for wireless communication at a UE, comprising a processor; memory coupled with the processor, the processor configured to perform a method of aspect 32.

Aspect 50: An apparatus for wireless communication at a UE, comprising at least one means for performing a method of aspect 32.

Aspect 51: A non-transitory computer-readable medium storing code for wireless communication at a UE, the code comprising instructions executable by a processor to perform a method of aspect 32.

It should be noted that the methods described herein describe possible implementations, and that the operations and the operations may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example operation that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, the processor configured to:
receive, at a source cell served by a network entity, signaling that triggers a handover to a target cell;
receive a first set of parameters associated with the target cell, the first set of parameters indicating that the target cell is served by the network entity; and
transmit, to the target cell, an uplink communication in accordance with a timing advance value for the target cell, the timing advance value for the target cell derived from a timing advance value for the source cell based at least in part on the target cell being served by the network entity.

2. The apparatus of claim 1, wherein the processor is further configured to:
receive a second set of parameters associated with the source cell;
compare the first set of parameters associated with the target cell to the second set of parameters associated with the source cell; and
determine the network entity serving the target cell based at least in part on the comparison.

3. The apparatus of claim 1, wherein the processor is further configured to:
receive, via a system information block, the first set of parameters that include an identifier of the network entity; and
determine the network entity to serve the target cell based at least in part on the identifier.

4. The apparatus of claim 1, wherein the processor is further configured to:
determine a timing value added to an estimated timing advance at the UE based at least in part on the target cell being served by the network entity, the timing advance value for the target cell derived from the timing value.

5. The apparatus of claim 1, wherein the processor is further configured to:
determine a timing value for random access channel transmission based at least in part on the target cell being served by the network entity, the timing advance value for the target cell derived from the timing value.

6. The apparatus of claim 1, wherein to receive the first set of parameters, the processor is further configured to:
receive, from the target cell, a system information block that includes the first set of parameters associated with the target cell.

7. The apparatus of claim 1, wherein to receive the first set of parameters, the processor is further configured to:
receive, from the source cell, the first set of parameters associated with the target cell.

8. The apparatus of claim 1 further comprising an antenna array, wherein the processor is further configured to:
perform the handover to the target cell based at least in part on the transmission of the uplink communication.

9. The apparatus of claim 1, wherein the first set of parameters comprises at least one of ephemeris information, a common timing advance, a medium access control layer parameter, a cell-specific offset, or any combination thereof.

10. The apparatus of claim 9, wherein the medium access control layer parameter comprises a scheduling offset parameter other than a cell-specific offset parameter.

11. The apparatus of claim 1, wherein the signaling that triggers the handover comprises a handover command or a fulfilled conditional handover or both.

12. An apparatus for wireless communication at a user equipment (UE), comprising:
a processor; and
memory coupled with the processor, the processor configured to:
receive, at a source cell served by a network entity, signaling that triggers a handover to a target cell;
receive a timing advance command that indicates a timing offset associated with the target cell; and
transmit, to the target cell, an uplink communication in accordance with a timing advance value for the target cell, the timing advance value for the target cell derived based at least in part on the timing offset.

13. The apparatus of claim 12, wherein the processor is further configured to:
receive an information element indicating that the target cell is served by the network entity, the timing advance value derived based at least in part on the information element.

14. The apparatus of claim 12, wherein the processor is further configured to:
receive an information element indicating that the UE is to use the timing offset associated with the target cell to derive the timing advance value for the target cell.

15. The apparatus of claim 12, wherein the processor is further configured to:
determine that the timing advance command comprises a valid timing advance command value; and
determine that the target cell is served by the network entity based at least in part on the timing advance command that includes the valid timing advance command value.

16. The apparatus of claim 12 further comprising an antenna array, wherein the processor is further configured to:
perform the handover to the target cell based at least in part on the transmission of the uplink communication.

17. The apparatus of claim 12, wherein the signaling that triggers the handover comprises the timing advance command or an information element or both.

18. The apparatus of claim 12, wherein the signaling that triggers the handover comprises a handover command or a fulfilled conditional handover or both.

19. An apparatus for wireless communication at a network entity, comprising:
a processor; and
memory coupled with the processor, the processor configured to:
output signaling that triggers a handover from a source cell to a target cell;
output a first set of parameters associated with the target cell; and
obtain an uplink communication in accordance with a timing advance value for the target cell, the timing advance value for the target cell derived from a timing advance value for the source cell.

20. The apparatus of claim 19, wherein the first set of parameters indicates that the source cell and the target cell are served by the network entity.

21. The apparatus of claim 20, wherein the processor is further configured to:
output an identifier of the network entity; and
determine the network entity serving the target cell based at least in part on the identifier.

22. The apparatus of claim 19, wherein the processor is further configured to:
determine a timing value for an estimated timing advance based at least in part on the source cell and the target cell being served by the network entity, the timing advance value for the target cell being based at least in part on the timing value.

23. The apparatus of claim 19, wherein the processor is further configured to:
determine a timing value for random access channel transmission based at least in part on the source cell and the target cell being served by the network entity, the timing advance value for the target cell being based at least in part on the timing value.

24. The apparatus of claim 19 further comprising an antenna array, wherein to output the first set of parameters, the processor is further configured to:
output a system information block that includes the first set of parameters associated with the target cell.

25. The apparatus of claim 19, wherein the first set of parameters comprises at least one of ephemeris information, a common timing advance, a medium access control layer parameter, a cell-specific offset, or any combination thereof.

26. The apparatus of claim 25, wherein the medium access control layer parameter comprises a scheduling offset parameter other than a cell-specific offset parameter.

27. The apparatus of claim 19, wherein the signaling that triggers the handover comprises a handover command or a fulfilled conditional handover or both.

28. An apparatus for wireless communication at a network entity, comprising:
a processor; and
memory coupled with the processor, the processor configured to:
output signaling that triggers a handover from a source cell to a target cell;
output a timing advance command that indicates a timing offset associated with the target cell; and
obtain an uplink communication in accordance with a timing advance value for the target cell, the timing advance value for the target cell being based at least in part on the timing offset.

29. The apparatus of claim 28 further comprising an antenna array, wherein the processor is further configured to:
output an information element indicating that the target cell is served by the network entity.

30. The apparatus of claim 28, wherein the processor is further configured to:
output an information element indicating that the timing advance value is based at least in part on the timing offset associated with the target cell.
